(19) United States
(12) Patent Application Publication
(10) Pub. No.: US 2022/0180368 A1
(43) Pub. Date: Jun. 9, 2022

(54) Risk Detection, Assessment, And Mitigation Of Digital Third-Party Fraud

(71) Applicant: Guardinex LLC, Bala Cynwyd, PA (US)

(72) Inventors: Aravind Immaneni, Glenside, PA (US); Ernest E. Fontes, Columbus, OH (US)

(21) Appl. No.: 17/543,111

(22) Filed: Dec. 6, 2021

Related U.S. Application Data
(60) Provisional application No. 63/121,270, filed on Dec. 4, 2020.

(51) Int. Cl. G06Q 20/40; G06Q 20/42; G06Q 20/36; G06N 20/00

(52) U.S. Cl. CPC G06Q 20/4016; G06Q 20/4014; G06N 20/00; G06Q 20/42; G06Q 20/3674; G06Q 20/407

(57) ABSTRACT

Disclosed is a computer-implemented method for preemptively or otherwise reducing the risk of detecting false positives of a third-party fraud in an application for a new account by an Applicant.

### CROSS REFERENCE TO RELATED APPLICATIONS

This application claims benefit under 35 U.S.C. § 119(e) of Provisional U.S. Patent Application No. 63/121,270, filed Dec. 4, 2020, the contents of which are hereby incorporated by reference in their entirety.

### FIELD OF THE INVENTION

The present disclosure relates generally to the field of computing system security, and more specifically to detecting, assessing, and mitigating the risk of third-party fraud in customer interactions with a service provider, with assistance of dark web analytics.

### BACKGROUND

The present disclosure generally relates to monitoring the dark web for leaked data related to a customer's log-in credentials (CLC) or other datapoints at a service provider. CLC include usernames, email addresses, passwords, PIN codes, and other personally identifiable information (PII). Network-connected computing systems often require that one or more CLC be provided and authenticated before granting computer access to services and information. For example, an end user of a computing device such as a mobile device, a desktop, or a laptop may provide CLC to access an online financial services account or to facilitate an online transaction through that financial services account.

Most customers tend to reuse a limited set of CLC such as their e-mails and passwords across a multitude of service providers. If a customer's CLC are breached at the first service provider, the likelihood of compromise of such CLC increases at the second service provider. Credential breaches over the last few years have increased exponentially with sensitive CLC and PII data now becoming available on the dark web. In addition to the CLC data, the customer's sensitive personal data are not only widely stolen from past security breaches but are also traded on the dark web. These can include personally Identifiable Information (PII) such as street address, phone number, mother's maiden name, and social security number. Fraudsters avail answers to a customer's other security questions—typically referred to as out-of-wallet questions—and can now access accounts and reset passwords using a combination of the compromised data even in absence of the specific username and password.

In fact, malicious users, fraudsters, or hackers can also break into a customer's primary email account or gain access to the customer's mobile phone. They can then trigger a password reset at the service provider and use the password reset link to gain access to the service.

### Third-Party Fraud

Digital third-party fraud relates to three parties, generally: (1) an applicant seeking service from a service provider (“Applicant”); (2) the service provider such as a financial institution (“Service Provider”); and (3) a fraudster pretending to be the applicant (“Fraudster”). Digital third-party fraud refers to fraud committed by someone other than the Applicant—a Fraudster pretending to be the Applicant by using the Applicant's identity. For example, when the Applicant plans to open an account with the Service Provider such as for a credit card, the Fraudster pretends to be, or assumes the identity of, the Applicant, to defraud the financial institution into a financial loss. For example, about 0.5% of all credit-card applications are fraudulent. So for example, a set of 100,000 applications will have 500 fraudulent applications and 99,500 good applications.

### First-Party Fraud

In contrast to the third-party fraud, digital first-party fraud relates to the Applicant and the Service Provider. In the context of a financial institution, the Applicant applies for credit with no intention of ever paying back the loan, which is then treated as a credit loss by the financial institution. In other words, the Applicant himself is the Fraudster.

### Synthetic Fraud

Synthetic fraud is a type of first-party fraud where the applicant does not exist, but a fake identity and even a credit history—in a financial institution context, for example—has been created with the purpose of committing the fraud. Most financial institutions treat synthetic fraud as first-party fraud.

The present invention relates to a third-party fraud: its risk detection, assessment, and mitigation. Service Providers take measures to reduce and/or eliminate the fraud. In the first step, such fraud is identified. More specifically, this invention relates to providing a novel method, a computer program product, and a computing system to reduce the false positives in identifying such third-party fraud. When an Applicant to the Service Provider such as a financial institution does exist, and the Fraudster is stealing that customer's identity to commit the fraud. More specifically, this invention relates to credit-card application fraud and its mitigation. However, the present invention also relates to other service providers for products such as mortgage, insurance, deposit, and investments.

### SUMMARY OF THE INVENTION

Fraud risk detection, assessment, and mitigation begins by collating the information about a given customer or Applicant across the dark web, in which, one can make a determination about the password hygiene, for example, password complexity, reuse of variants of the same password across multiple sites, to determine the risk of credentials being compromised. By combining this analysis with information about the reputation of the customer's email and mobile phone, (for example, length of service, participation in prior fraud, and recent change in ownership), one can further differentiate the risks. A further enhancement of risk can be achieved by monitoring the dark web chatter for planned attacks against the Service Provider while also accounting for the unique security controls for customer authentication at the Service Provider. This allows for a pre-emptive risk detection and mitigation at the Service Provider using a “Risk Score” for a given customer login-credential CLC (username and password) at a given Service Provider and a specific point in time. However, in determining the risk score, many false positives may result.

According to one aspect of the present disclosure, information about the Users or Customers of a Service Provider can be continuously aggregated using machine learning models from a multitude of cross-industry sources on the open web or the Deep Web including data from the Dark Web to form a detailed profile about each Customer. The data gathered about each individual Applicant or User or Customer resembles the data gathering efforts undertaken by Malicious Users or Fraudsters. Another key input is the unique controls of a Service Provider for the authentication and password reset process combined with monitoring of the unique threats against a given Service Provider. The resulting data can then be used to form a proactive and dynamic risk score but with reduced false positives in real-time for any given customer that is tuned to the unique controls of a given service provider.
In one embodiment, this invention relates to a computer implemented method for reducing the risk of detecting false positives of a third-party fraud in an application for an account by an Applicant, comprising the steps of:
   (A) taking at least one first datapoint from the Applicant's application;
   (B) continuously searching first data elements (Xs) associated with said at least one first datapoint to determine breaching of said at least one first datapoint, wherein said searching is performed in at least one website of the dark web and wherein said dark web is accessible over an anonymous network;
   (C) weighting the data elements of Step (B), wherein the weighted first data elements are called WXs;
   (D)
      (D1) providing at least one second data element (Ys) gathered from information that is not from the dark web; or
      (D2) continuously searching second data elements (Ys) associated with at least one second datapoint that is gathered from information not from the dark web to determine breaching of said at least one second datapoint;
   (E) weighting the second data elements of Step (D2), wherein the weighted second data elements are called WYs;
   (F) combining the weighted first data elements (WXs) from Step (C) with at least one second data element (Ys) from Step (D1) (WXs+Ys), or combining the weighted first data elements (WXs) from Step (C) with the weighted second data elements (WYs) of Step (E) (WXs+WYs);
   (G) determining a reduced-False Positives Risk Score for said application of said Applicant Cn using the formula:

r-R_{fp}(Cₙ,SPi,t)=f{X1,X2,X3 . . . ;Y1,Y2,Y3 . . .}
wherein the reduced-False Positives Risk Score r-R_{fp} is specific to a Customer Cn, at a specific Service Provider SPi, and at a given time t;
wherein said reduced-False Positives Risk Score is a function of Xs and Ys, wherein said Xs are data elements from the dark web and Ys are data elements not from the dark web;
wherein said reduced-False Positives Risk Score is calculated using multivariate machine-learning models such that they intelligently analyze said data elements Xs and Ys and provide said reduced-False Positives Risk Score;
wherein said account is optionally a new account; and
wherein said reduction in risk of detecting false positives of the third-party fraud is optionally preemptively performed on an account or an Applicant.
In another embodiment, this invention relates to a computer implemented method as described above, wherein the information not from the dark web, that is the second data elements (Ys), is selected from the group consisting of:
   (i) behavioral data,
   (ii) deep web information; wherein, optionally, said searching of data elements in the deep web is based, at least in part, on the information from the dark web,
   (iii) surface web information; wherein, optionally, searching the data elements in the surface web are based, at least in part, on the data elements' information from the dark web and/or the deep web,
   (iv) additional fraudster tactics, and
   (v) a combination of the above.
In yet another embodiment, this invention relates to a computer implemented method as described above, wherein the second data elements (Ys) are selected from:
behavioral difference in subjective behavior of a Fraudster as an Applicant in a third-party fraud and a genuine Applicant; behavioral difference in objective behavior of a Fraudster as an Applicant in a third-party fraud and a genuine Applicant; the time of the day of the application; the day of the week of the application; the month of the application; the propensity of the Fraudster to use the same email for multiple accounts but with different identities; the propensity of the Fraudster to use the same phone number for multiple accounts but with different identities; surface web information relating to differentiated information on telephone carriers; surface web information relating to recycled phone numbers; surface web information relating to temporary phone numbers; surface web information relating to phone numbers with no prior data; surface web information relating to geolocation of the phone number versus the address on the application provided by the Applicant; differentiated information in an email relating to domain names; differentiated information in the email relating to historical activity; differentiated information in the email relating it use in the past for fraud; differentiated information in emails relating to the recency of the email account; differentiated information in emails relating to the responsiveness of the account; marketing data that includes household information; marketing data that includes address of the Applicant; marketing data that includes other e-mails used by the household of the Applicant; marketing data that includes other e-mails used by the household which does not have the same historical footprint as the email of the Applicant; association of the PII data provided by the Applicant versus what is found in the marketing data; Fraudster tactic of fake email for the Applicant that is reverse engineered and incorporated into the machine learning model; Fraudster tactic of burner email for the Applicant that is reverse engineered and incorporated into the machine learning model; Fraudster tactic of fake phone number for the Applicant that is reverse engineered and incorporated into the machine learning model; Fraudster tactic of burner phone number for the Applicant that is reverse engineered and incorporated into the machine learning model; Fraudster tactic of spam emails for the Applicant that is reverse engineered and incorporated into the machine learning model; Fraudster tactic relating to malware attack information for the Applicant that is reverse engineered and incorporated into the machine learning model; Fraudster tactic of information on compromised phones for the Applicant that is reverse engineered and incorporated into the machine learning model; Fraudster tactic of cases where the 2-step authentication has failed for the Applicant that is reverse engineered and incorporated into the machine learning model; and combination of the above.
In one embodiment, this invention relates to a computer implemented method as described above, wherein said reduced-False Positives Risk Score, as it relates to said specific Service Provider SPi, is dynamically communicated to said specific Service Provider SPi prior to a transaction request, and not after said transaction request using an application programming interface (API).
In another embodiment, this invention relates to a computer implemented method as described above, wherein said reduced-False Positives Risk Score is compared dynamically or periodically with a pre-determined threshold Risk Score; and taking one of the following steps:
   (F1) modifying an authentication requirement for the Applicant and seeking said authentication from the Applicant, wherein said authentication requirement is a function of the breach of said pre-determined threshold Risk Score;
   (F2) modifying an authentication requirement for the Applicant, while temporarily suspending services to said Applicant, pre-emptively notifying the Applicant of said suspension, seeking said authentication from said Applicant, and restarting or shutting down services connected to said Applicant.
In yet another embodiment, this invention relates to a computer implemented method as described above, wherein modifying the authentication requirement comprises identifying an enhanced security protocol to authenticate the User.
In one embodiment, this invention relates to a computer implemented method as described above, wherein the enhanced security protocol comprises a multi-factor authentication of the User.
In another embodiment, this invention relates to a computer implemented method as described above, wherein the data elements comprise one of dynamic content, multimedia content, audio content, and a picture.
In yet another embodiment, this invention relates to a computer implemented method as described above, wherein the data elements are searched using configurable search parameters.
In one embodiment, this invention relates to a computer implemented method as described above, wherein the anonymous network comprises a Tor server.
In another embodiment, this invention relates to a computer implemented method as described above, wherein said behavioral data is selected from behavioral difference between a Fraudster and a genuine Applicant, the time of the day of the application, the propensity of the Fraudster to use the same e-mail and or phone number for multiple accounts but with different identities.
In yet another embodiment, this invention relates to a computer implemented method as described above, wherein said surface web information is selected from data on phone carriers, recycled phone numbers, temporary phone numbers, phone numbers with no prior data, and geolocation of the phone number versus the address on the application provided by the Applicant, domain name information in e-mail, historical activity of the e-mail, the recency of the e-mail account, and the responsiveness of the account.
In one embodiment, this invention relates to a computer implemented method as described above, wherein said surface web information is selected from marketing data, household information, household address, other e-mails used by the household, and association of the PII data provided by the Applicant versus what is found in the marketing databases.
In another embodiment, this invention relates to a computer implemented method as described above, wherein the dark web data associated with the Applicant datapoint is weighted favorably to reduce the false positives.
In one embodiment, this invention relates to a computer program product comprising: a computer readable storage medium comprising computer readable program code embodied therewith, the computer readable program code comprising:
   (A) computer readable program code configured to take in at least one first datapoint from the Applicant's application;
   (B) computer readable program code configured to continuously searching first data elements (Xs) associated with said at least one first datapoint to determine breaching of said at least one first datapoint, wherein said searching is performed in at least one website of the dark web and wherein said dark web is accessible over an anonymous network;
   (C) computer readable program code configured to weighting the data elements of Step (B), wherein the weighted first data elements are called WXs;
   (D)
      (D1) computer readable program code configured to providing at least one second data element (Ys) gathered from information that is not from the dark web; or
      (D2) computer readable program code configured to continuously searching second data elements (Ys) associated with at least one second datapoint that is gathered from information not from the dark web to determine breaching of said at least one second datapoint;
   (E) computer readable program code configured to weighting the second data elements of Step (D2), wherein the weighted second data elements are called WYs;
   (F) a computer readable program code configured to combining the weighted first data elements (WXs) from Step (C) with at least one second data element (Ys) from Step (D1) (WXs+Ys), or combining the weighted first data elements (WXs) from Step (C) with the weighted second data elements (WYs) of Step (E) (WXs+WYs);
   (G) computer readable program code configured to determining a reduced-False Positives Risk Score for said application of said Applicant Cn using the formula:

r-R_{fp}(Cₙ,SPi,t)=f{X1,X2,X3 . . . ;Y1,Y2,Y3 . . . }
wherein the reduced-False Positives Risk Score R_{fp} is specific to a Customer Cn, at a specific Service Provider SPi, and at a given time t;
wherein said reduced-False Positives Risk Score is a function of Xs and Ys, wherein said Xs are data elements from the dark web and Ys are data elements not from the dark web; and
wherein said reduced-False Positives Risk Score is calculated using multivariate machine-learning models such that they intelligently analyze said data elements Xs and Ys and provide said reduced-False Positives Risk Score.
In another embodiment, this invention relates to a computer program product as recited above, wherein the information not from the dark web, that is the second data elements (Ys), is selected from the group consisting of:
   (i) behavioral data,
   (ii) deep web information; wherein, optionally, said searching of data elements in the deep web is based, at least in part, on the information from the dark web,
   (iii) surface web information; wherein, optionally, searching the data elements in the surface web are based, at least in part, on the data elements' information from the dark web and/or the deep web,
   (iv) additional fraudster tactics, and
   (v) a combination of the above.
In yet another embodiment, this invention relates to a computer program product as recited above, wherein the second data elements (Ys) are selected from:
behavioral difference in subjective behavior of a Fraudster as an Applicant in a third-party fraud and a genuine Applicant; behavioral difference in objective behavior of a Fraudster as an Applicant in a third-party fraud and a genuine Applicant; the time of the day of the application; the day of the week of the application; the month of the application; the propensity of the Fraudster to use the same email for multiple accounts but with different identities; the propensity of the Fraudster to use the same phone number for multiple accounts but with different identities; surface web information relating to differentiated information on telephone carriers; surface web information relating to recycled phone numbers; surface web information relating to temporary phone numbers; surface web information relating to phone numbers with no prior data; surface web information relating to geolocation of the phone number versus the address on the application provided by the Applicant; differentiated information in an email relating to domain names; differentiated information in the email relating to historical activity; differentiated information in the email relating it use in the past for fraud; differentiated information in emails relating to the recency of the email account; differentiated information in emails relating to the responsiveness of the account; marketing data that includes household information; marketing data that includes address of the Applicant; marketing data that includes other e-mails used by the household of the Applicant; marketing data that includes other e-mails used by the household which does not have the same historical footprint as the email of the Applicant; association of the PII data provided by the Applicant versus what is found in the marketing data; Fraudster tactic of fake email for the Applicant that is reverse engineered and incorporated into the machine learning model; Fraudster tactic of burner email for the Applicant that is reverse engineered and incorporated into the machine learning model; Fraudster tactic of fake phone number for the Applicant that is reverse engineered and incorporated into the machine learning model; Fraudster tactic of burner phone number for the Applicant that is reverse engineered and incorporated into the machine learning model; Fraudster tactic of spam emails for the Applicant that is reverse engineered and incorporated into the machine learning model; Fraudster tactic relating to malware attack information for the Applicant that is reverse engineered and incorporated into the machine learning model; Fraudster tactic of information on compromised phones for the Applicant that is reverse engineered and incorporated into the machine learning model; Fraudster tactic of cases where the 2-step authentication has failed for the Applicant that is reverse engineered and incorporated into the machine learning model; and combination of the above.
In one embodiment, this invention relates to a system comprising:
   (A) a data processor configured to execute a first set of instructions to take in at least one first datapoint from an Applicant's application;
   (B) a data processor configured to execute a first set of instructions to continuously searching first data elements (Xs) associated with said at least one first datapoint to determine breaching of said at least one first datapoint, wherein said searching is performed in at least one website of the dark web and wherein said dark web is accessible over an anonymous network;
   (C) a data processor configured to execute a first set of instructions to weighting the data elements of Step (B), wherein the weighted first data elements are called WXs;
   (D)
      (D1) a data processor configured to execute a first set of instructions to providing at least one second data element (Ys) gathered from information that is not from the dark web; or
      (D2) a data processor configured to execute a first set of instructions to continuously searching second data elements (Ys) associated with at least one second datapoint that is gathered from information not from the dark web to determine breaching of said at least one second datapoint;
   (E) a data processor configured to execute a first set of instructions to weighting the second data elements of Step (D2), wherein the weighted second data elements are called WYs;
   (F) a data processor configured to execute a first set of instructions to combining the weighted first data elements (WXs) from Step (C) with at least one second data element (Ys) from Step (D1) (WXs+Ys), or combining the weighted first data elements (WXs) from Step (C) with the weighted second data elements (WYs) of Step (E) (WXs+WYs);
   (G) a data processor configured to execute a first set of instructions to determining a reduced-False Positives Risk Score for said application of said Applicant Cn using the formula:

R_{fp}(Cₙ,SPi,t)=f{X1,X2,X3 . . . ;Y1,Y2,Y3 . . . }
wherein the reduced-False Positives Risk Score R_{fp} is specific to a Customer Cn, at a specific Service Provider SPi, and at a given time t;
wherein said reduced-False Positives Risk Score is a function of Xs and Ys, wherein said Xs are data elements from the dark web and Ys are data elements not from the dark web;
wherein said reduced-False Positives Risk Score is calculated using multivariate machine-learning models such that they intelligently analyze said data elements Xs and Ys and provide said reduced-False Positives Risk Score;
wherein said Applicant is optionally opening a new account; and
wherein said reduction in risk of detecting false positives of the third-party fraud is optionally preemptively performed on the new account or the Applicant..
In another embodiment, this invention relates to a system as described above, wherein the information not from the dark web, that is the second data elements (Ys), is selected from the group consisting of:
   (i) behavioral data,
   (ii) deep web information; wherein, optionally, said searching of data elements in the deep web is based, at least in part, on the information from the dark web,
   (iii) surface web information; wherein, optionally, searching the data elements in the surface web are based, at least in part, on the data elements' information from the dark web and/or the deep web,
   (iv) additional fraudster tactics, and
   (v) a combination of the above.
In yet another embodiment, this invention relates to a system as described above, wherein the second data elements (Ys) are selected from:
behavioral difference in subjective behavior of a Fraudster as an Applicant in a third-party fraud and a genuine Applicant; behavioral difference in objective behavior of a Fraudster as an Applicant in a third-party fraud and a genuine Applicant; the time of the day of the application; the day of the week of the application; the month of the application; the propensity of the Fraudster to use the same email for multiple accounts but with different identities; the propensity of the Fraudster to use the same phone number for multiple accounts but with different identities; surface web information relating to differentiated information on telephone carriers; surface web information relating to recycled phone numbers; surface web information relating to temporary phone numbers; surface web information relating to phone numbers with no prior data; surface web information relating to geolocation of the phone number versus the address on the application provided by the Applicant; differentiated information in an email relating to domain names; differentiated information in the email relating to historical activity; differentiated information in the email relating it use in the past for fraud; differentiated information in emails relating to the recency of the email account; differentiated information in emails relating to the responsiveness of the account; marketing data that includes household information; marketing data that includes address of the Applicant; marketing data that includes other e-mails used by the household of the Applicant; marketing data that includes other e-mails used by the household which does not have the same historical footprint as the email of the Applicant; association of the PII data provided by the Applicant versus what is found in the marketing data; Fraudster tactic of fake email for the Applicant that is reverse engineered and incorporated into the machine learning model; Fraudster tactic of burner email for the Applicant that is reverse engineered and incorporated into the machine learning model; Fraudster tactic of fake phone number for the Applicant that is reverse engineered and incorporated into the machine learning model; Fraudster tactic of burner phone number for the Applicant that is reverse engineered and incorporated into the machine learning model; Fraudster tactic of spam emails for the Applicant that is reverse engineered and incorporated into the machine learning model; Fraudster tactic relating to malware attack information for the Applicant that is reverse engineered and incorporated into the machine learning model; Fraudster tactic of information on compromised phones for the Applicant that is reverse engineered and incorporated into the machine learning model; Fraudster tactic of cases where the 2-step authentication has failed for the Applicant that is reverse engineered and incorporated into the machine learning model; and combination of the above.
In one embodiment, this invention relates to a method as described above, wherein the method further comprises:
generating a machine learning model with feedback from the Service Provider on the accuracy of the previous score.

### BRIEF DESCRIPTION OF THE DRAWINGS

The embodiments are illustrated by way of example and not limitation in the figures of the accompanying drawings in which like references indicate similar elements.

FIG. 1 shows the (reduced-False Positives) Risk Scoring Engine (170) that proactively identifies the false positives risk for individual Customers who use the services of a multitude of Service Providers (110) that are connected to the Internet (100) in accordance with certain embodiments of the present disclosure.

FIG. 2 is a depiction of the credentials data for a typical User (120) in accordance with certain embodiments of the present disclosure.

FIG. 3 is an illustration of some of the numerous controls (111) of a given Service Provider (110) for validating and resetting User credentials. The Credential Risk Scoring Engine (or the reduced-False Positives Risk Scoring Engine) can be tuned to tailor the risk score based on the unique controls at each Service Provider in accordance with certain embodiments of the present disclosure.

FIG. 4 describes the typical process (140) by which the customer credential data is stolen, aggregated, and weaponized against multiple Service Providers in accordance with certain embodiments of the present disclosure.

FIGS. 4.1 through 4.4 are Flow Charts that describe the high-level processes for building key aspects of the solution. They include building the initial Service Provider and Customer Profiles and the Machine Learning Models for Risk Scoring. They also show the proactive real-time risk scoring and the feedback mechanism to improve the predictions.

FIG. 5 describes the workings of the Real-Time Reduced-False Positives Risk Scoring Engine (170) in accordance with certain embodiments of the present disclosure.

FIG. 6.1 is a visual representation of some of the data elements of a given customer and Service Provider, that are fed into the Machine Learning Model for the generation of the dynamic real-time risk scores (R) using dark web data elements (Xs).

FIG. 6.2 is a visual representation of some of the data elements of a given customer and Service Provider, that are fed into the Machine Learning Model for the generation of the dynamic real-time risk scores with reduced false positives (reduced-False Positives Risk Score r-R_{fp}) using dark web data elements (Xs) and non-dark web data elements (Ys).

FIG. 7 is a plot of the Risk Scores of multiple legitimate Users and multiple Malicious Users/hackers at a given Service Provider.

FIG. 8 shows the False Positives detection process in a review of the third-party fraud application.

FIG. 9 shows the True Positive Rate as a function of the False Positive Rate.

### DETAILED DESCRIPTION OF THE INVENTION

By a “Service Provider” is meant any institution that provides a service to a multitude of Users or Customers over the internet and requires secure authentication to uniquely identify the User and allow access to their services. A Service Provider could be a bank, a financial services institution, a retailer, an online merchant, a social media platform, an educational institution, a news site, a business corporation, a non-profit organization, an enterprise, a brokerage firm, a credit union, a utility provider, an online video-streaming service, an online gaming service, a blog site, and many others. In many instances in this disclosure the Service Provider is abbreviated as “SP”.

By “User” or “Customer” or “Applicant” is meant one or more real persons; non-real persons, bots for example; formal or informal entities, for example, a corporation, an unincorporated business; a family unit or sub-unit; or a formal or an informal unit of people that is interested in partaking the services of such SP.

The dark web, the deep web, and the surface web may be collectively referred to as the WEB.

For purposes of illustrating certain exemplary techniques for reducing the risk of detecting false positives of a third-party fraud in application for new account by an Applicant, the risk profile, and enhancing the authentication of the User with assistance from dark web analytics in the computing environment such as the internet, it is important to understand the communications that may be traversing the network environment. The following foundational information may be viewed as a basis from which the present disclosure may be properly explained.

The secure authentication process to avail service at a given Service Provider often requires that the Customer or the User provide customer log-in credentials (CLC) and be validated before granting access to computing services and information. For example, an end user of a computing device, for example, a mobile device, desktop, or a laptop, may provide CLC to access an online financial services account or to facilitate an online transaction by means of that financial services account.

In the following detailed description of embodiments, reference is made to the accompanying drawings which form a part hereof, and which are shown by way of illustrations. It is to be understood that features of various described embodiments may be combined, other embodiments may be utilized, and structural changes may be made without departing from the scope of the present disclosure. It is also to be understood that features of the various embodiments and examples herein can be combined, exchanged, or removed without departing from the scope of the present disclosure.

As will be appreciated by one skilled in the art, aspects of the present disclosure may be illustrated and described herein in any number of patentable classes or contexts including any new and useful process, machine, manufacture, or composition of matter, or any new and useful improvement thereof. Accordingly, aspects of the present disclosure may be implemented entirely in hardware, entirely in software (including firmware, resident software, and micro-code) or combining software and hardware implementations that may all generally be referred to herein as a “circuit,” “module,” “component,” “logic,” “engine,” “generator,” “agent,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but is not limited to, an electronic, magnetic, optical, electromagnetic, or semiconductor system, apparatus, or device, or any suitable combination of the foregoing. More specific examples (a non-exhaustive list) of the computer readable storage medium includes the following: a portable computer diskette, a hard disk, a random access memory (RAM), a read-only memory (ROM), a programmable read-only memory (PROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (RF), or any suitable combination of the foregoing, and the like.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, assembly language, or other programming languages.

The above program code may execute entirely on a local computer (for example, server, server pool, desktop, laptop, and appliance), partly on the local computer, as a stand-alone software package, partly on the local computer and partly on a remote computer, or entirely on a remote computer. In the latter scenario, the remote computer may be connected to the local computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS). Generally, any combination of one or more local computers and/or one or more remote computers may be utilized for executing the program code. Aspects of the present disclosure are described herein with reference to flowchart illustrations, interaction diagrams, and/or block diagrams of methods, apparatuses (systems) and computer program products according to embodiments of the disclosure. It will be understood that each block of the flowchart illustrations and/or block diagrams, each interaction of the block diagrams, combinations of blocks in the flowchart illustrations and/or block diagrams, and/or combinations of interactions in the block diagrams can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks and/or functions/acts specified in the interactions of the block diagram block or blocks.

These computer program instructions may also be stored in a computer readable medium that, when executed, can direct a computer, other programmable data processing apparatus, or other devices to function in a particular manner, such that the instructions when stored in the computer readable medium produce an article of manufacture including instructions that, when executed, cause a computer to implement the function/act specified in the flowchart and/or block diagram block or blocks and/or the function/act specified in the interaction or interactions of the block diagrams. The computer program instructions may also be loaded onto a computer, other programmable instruction execution apparatus, or other devices to cause a series of operations to be performed on the computer, other programmable apparatuses or other devices to produce a computer implemented process such that the instructions, which execute on the computer or other programmable apparatus provide processes for implementing the functions/acts specified in the flowchart and/or block diagram block or blocks and/or functions/acts specified in the interaction or interactions of the block diagrams.

The world wide web is a software layer that provides a mechanism for exchanging information over the Internet. The world wide web runs over a system of Internet servers that can support documents formatted in Hypertext Markup Language (HTML) and use Hypertext Transfer Protocol (HTTP), which is an application protocol that facilitates data communications of the HTML documents in distributed information systems.

### The Dark Web

Some statistics indicate that common (for example, commercial) search engines provide access to only 5-15% of the content available over the Internet. This content, which is accessible by common search engines, is referred to as the surface web. The deep web and dark web make up the rest of the content. The deep web contains information that cannot be indexed and found by a typical search engine. For example, deep web information may be contained in websites (for example government databases and libraries) and searched directly in the website rather than through a common search engine. Other examples of deep webpages include pages that are not linked by other pages searchable by a standard search engine, archived versions of webpages, dynamic pages that are returned by a server in response to a specific query, and textual content encoded in multimedia files. Standard browsers, however, can generally be used to access deep web content that is not part of the dark web.

The dark web is a subset of objects—for example, pages of HTML, and non-traditional content—of the deep web and is accessible over anonymous network. In the dark web, the information or content is intentionally hidden and is inaccessible through standard web browsers. Special software is used to access the dark web including, but not limited to ‘The Onion Router’ or ‘Tor,’ and Invisible Internet Project (I2P) services. I2P is an anonymous peer-to-peer distributed communication layer designed to allow applications to send messages to each other pseudonymously and securely. Tor is software that can be installed into a browser to enable special connections to dark websites that offer hidden services and resources. These hidden services and resources may be provisioned in non-standard top-level domains such as .Onion (dot onion), for example.

Thus, once a dark top-level domain is identified, at least some dark websites can be identified based on their corresponding uniform resource locator (URL). When the Tor browser is invoked, a connection may be made to a Tor router or Onion router that encrypts the network address, for example, Internet Protocol (IP) address, of the connecting device. The communication also gets propagated through numerous randomly selected routers, potentially around the globe. Tor's encryption and routing techniques prevent the communication from being traced back to its source. Thus, user identities and host identities can remain anonymous. This ability to maintain anonymity in browsing and serving activities essentially invites illegal activity to flourish within the Tor network.

The Internet is a global network infrastructure interconnecting a vast array of networks. Anonymous network is a portion of the Internet in which special anonymizing software networks allow access to the dark web. The dark web is widely known for facilitating illicit and/or nefarious activities due to anonymity associated with special browsers, for example, Tor, used to access services and resources. For example, the dark web has been used for activities that include, but are not limited to human trafficking, wildlife trafficking, illegal sales and distribution of weapons, money laundering and theft, as well as offering an environment where these activities can be secretly discussed, planned, and executed. In particular examples, the dark web has been used to sell stolen credit card details and to discuss possible hacking methods to bypass a financial institution's secure payment systems. Because the dark web offers anonymity to its community of users, users may be willing to communicate more freely regarding their intents, plans, desires, knowledge or any other information related to topics, for example, hacking, and stealing, that motivate the users to conceal their identities.

### Fraudsters

Hackers, also known as ‘malicious users,’ have a multitude of tools available to hack into computer systems of organizations, such as banks and other financial institutions. Millions of dollars have been lost through financial systems due to security holes in associated payment systems. In a recent real-life scenario, hackers attacked a particular financial system and stole more than 2.5 million pounds from customer accounts. Although breaching the financial system itself may not necessarily have involved the use of the dark web, news outlets reported that, prior to the attack, information exchanges among the community of users in the dark web included content related to the targeted financial institution and its computer security weaknesses or flaws. That is, ‘chatter’ increased on the dark web that pertained to the hacking and/or targeted financial institution. Due to the nature of the dark web, however, accessing its services and resources is not commonly done by reputable financial institutions and other enterprises. Consequently, indications of a risk that may be observed in the dark web is not generally or readily available to financial institutions or other enterprises. Hackers, malicious users, and fraudsters are all referred to as “Fraudsters” int eh disclosure herein.

Conventionally, in response to a breach of a company's data security, a press release may be issued, and affected customers may be notified. In some instances, compromised data may be used by criminals to open new credit accounts or to attempt to gain access to a customer's account. In some instances, such as when a Service Provider's records are compromised, a large amount of customer data, including multiple customer accounts, may be compromised. Data from such data breaches can end up being sold online through websites and private servers.

As used herein, the term “exposed data” or “compromised data” refers to any part of customer log-in credential (CLC) or personally identifying information (PII) that may have been compromised or breached, such that an unauthorized individual may have gained access to such information. In certain embodiments, the PII data may include names, dates of birth, usernames, passwords, addresses, social security numbers, email addresses, phone numbers, credit card numbers, bank information, other data, or any combination thereof. Such data may be used to identify a particular consumer, and which may be misused to attempt to open accounts—such as new services and lines of credit—to gain access to existing accounts, and so on and so forth.

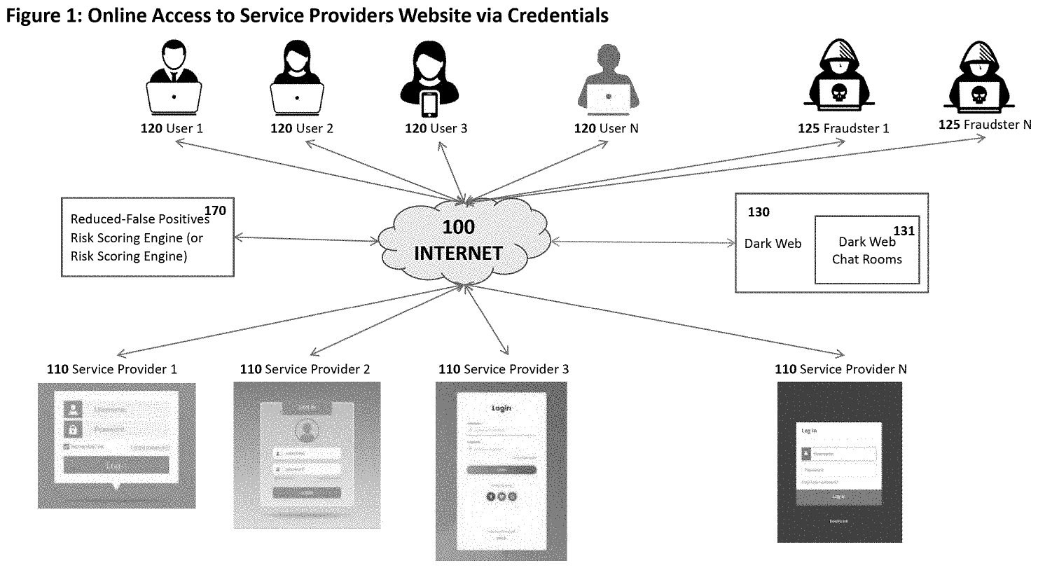

As shown in FIG. 1, communications in computing environment 100 may be inclusive of packets, messages, requests, responses, replies, queries, etc. Communications may be sent and received according to any suitable communication messaging protocols, including protocols that allow for the transmission and/or reception of packets in a network. Suitable communication messaging protocols can include a multi-layered scheme such as Open Systems Interconnection (OSI) model, or any derivations or variants thereof (for example, transmission control protocol/IP (TCP/IP), and user datagram protocol/IP (UDP/IP)). Particular messaging protocols may be implemented in the computing environment where appropriate and based on particular needs. Additionally, the term ‘information’ as used herein, refers to any type of binary, numeric, voice, video, textual, multimedia, rich text file format, HTML, portable document format (pdf), or script data, or any type of source or object code, or any other suitable information or data in any appropriate format that may be communicated from one point to another in electronic devices and/or networks. Information as used herein also includes fragments of such data.

In general, “servers,” “computing devices,” “network elements,” “database servers,” “client devices,” and “systems,” etc. (for example, 100, 110, and 170) in example computing environment 100, can include electronic computing devices operable to receive, transmit, process, store, or manage data and information associated with computing environment 100. As used in this document, the term “computer,” “processor,” “processor device,” or “processing element” is intended to encompass any suitable processing device. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, and Windows Server, as well as virtual machines adapted to virtualize execution of a particular operating system, including customized and proprietary operating systems.

As described below, a Risk Scoring Engine is a multivariate computer machine learning model for the risk scoring of fraud. Generally, it is AI based. It takes input from the dark web, as described below. The reduced-Reduced-False Positives Risk Scoring Engine (r-FPRS Engine) is a risk scoring engine that takes additional input from non-dark web sources, that is, the surface web, and/or the deep web, and/or the Applicant data source, as described infra. While the description infra is discussed in terms of the r-FPRS Engine, it applies equally to the generalized Risk Scoring Engine of the present invention, with the input source being the difference. Clearly, the weighting of the inputs could also be different.

Further, servers, computing devices, network elements, database servers, systems, client devices, system, etc. (for example, 100, 100, and 170) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, the reduced-False Positives Risk Scoring Engine or the generalized Risk Scoring Engine 170) can be at least partially (or wholly) cloud-implemented, web-based, or distributed to remotely host, serve, or otherwise manage data, software services and applications interfacing, coordinating with, dependent on, or used by other systems, services, and devices in computing environment 100. In some instances, a server, system, subsystem, and/or computing device can be implemented as some combination of devices that can be hosted on a common computing system, server, server pool, or cloud computing environment and share computing resources, including shared memory, processors, and interfaces.

In one implementation of the present invention, the r-FPRS Engine includes software to achieve the real-time risk score of a given set of CLC, data aggregation from the deep web, the dark web and the surface web, profiling of the Service Provider's controls, and real-time alerts, as outlined herein. Note that in one example, each of these elements can have an internal structure—for example, a processor and a memory element—to facilitate some of the operations described herein. In other embodiments, these features may be executed externally to these elements, or included in some other network element to achieve this intended functionality. Alternatively, other systems may include this software or reciprocating software that can coordinate with other network elements in order to achieve the operations, as outlined herein. In still other embodiments, one or several devices may include any suitable algorithms, hardware, software, firmware, components, modules, interfaces, or objects that facilitate the operations thereof.

Referring now to FIG. 1, it shows the reduced-False Positives Risk Scoring Engine (170) that proactively identifies the risk for a Service Providers connected to the internet (100). Customers of the Service Providers are Users 1 . . . N (120) that connect through their computer or mobile phones to access the unique services of each of the SP. Elements of FIG. 1 may be coupled to one another through one or more interfaces employing any suitable connections—wired or wireless—which provide viable pathways for network communications. Generally, the internet 100 and anonymous dark web network 130 represent a series of points or nodes of interconnected communication paths for receiving and transmitting packets of information that propagate through computing environment 100. A network, such as networks 100, 130, can comprise any number of hardware and/or software elements coupled to, and in communication with, each other through a communication medium. Such networks can include, but are not limited to, any local area network (LAN), virtual local area network (VLAN), wide area network (WAN) such as the Internet, wireless local area network (WLAN), metropolitan area network (MAN), Intranet, Extranet, virtual private network (VPN), any other appropriate architecture or system that facilitates communications in a network environment or any suitable combination thereof. Unlike network 100, however, anonymous network 130 is a special anonymizing software network that can be used to access the dark web, which contains websites that are not indexed and are inaccessible through standard web browsers.

On the dark web there are numerous chat groups (131) that are frequented by the Malicious Users: 1 . . . N (125). These anonymous chat groups and forums are where the Malicious Users (131) share their exploits, trade their breach data, discuss weakness in the controls at various Service Providers and plan/coordinate strategies for attack against Service Providers. Critical insights can be gleaned by monitoring this ‘chatter’ to manage the real-time risk of an attack against a given Service Provider.

Before Users (120) try to access the services at a Service Provider (110), they must first authenticate using their CLC. Concurrently, there are other Malicious Users, Threat Actors and Fraudsters (125) that are also trying to impersonate as the real Users to gain access to the secure services at the Service Providers (110). In one embodiment of the FPRS Engine, at the time of login, each SP (110) can check with the reduced-FPRS Engine (170) for the riskiness of the User's CLC (120). Each SP can make an independent decision on how to respond to the Risk Score returned by the r-FPRS Engine. In some cases, the Service Provider might decide to halt the login entirely or force the User or the Applicant to undergo an enhanced version of Authentication. However, because the r-FPRS Engine generates a dynamic risk score, the risk score is not transaction specific. In one embodiment, the dynamic risk score pre-emptively triggers enhanced authentication of the User by an SP, regardless of the occurrence of a transaction. Such preemptive authentication could be sought in case of a threshold level is breached by the risk score (as dynamically determined by the r-FPRS Engine).

In one embodiment, the r-FPRS Engine gathers information from the surface web the deep web and other non-dark web data in addition to the dark web on a continuous basis, and in real time, has a risk score available for a User or the Applicant and/or his credentials. For example, for a hypothetical person John Doe, whose username is JohnDoel@acmemail.com and password of USA50, the FPRS Engine provides a dynamic Risk Score, that is for the moment it is desired. The SP can move forward, given the risk score, in allowing the User to avail the SP's services.

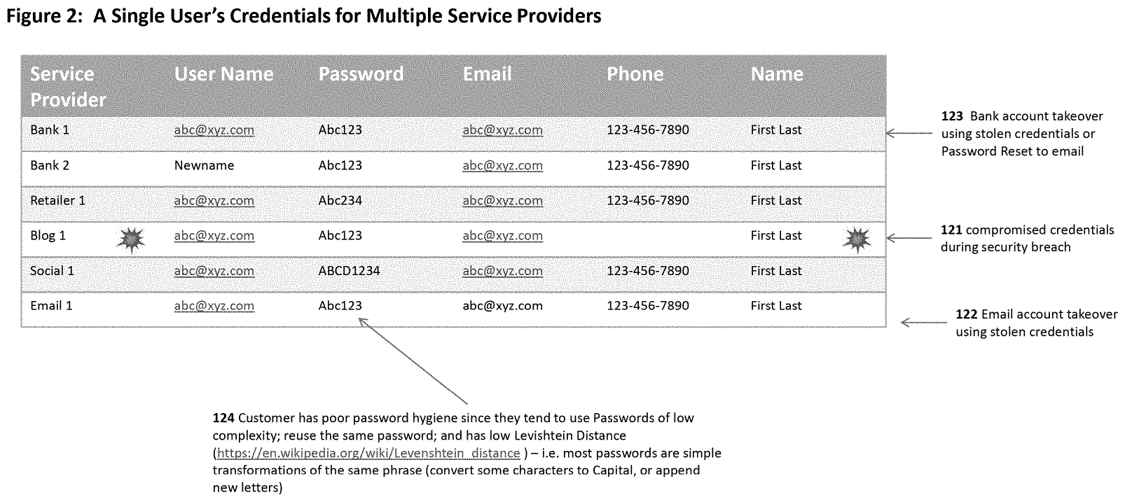

FIG. 2 is a depiction of the CLC data for a typical User or the Applicant (120). The User or the Applicant might have signed up for a multitude of services from a range of Service Providers (110). These secure services could include Banks, Financial Institutions, Retailers, Social Media Platform, Email Services, Digital Media Content Providers, Shopping Networks, Utilities, Travel Industries, Vacations Rentals, Subscription Services, Medical Services, and the like. For each Service Provider, the User or the Applicant has a unique set of CLC that typically consists of username and password. In some instances, the username might be different than the email address. From a User's perspective, this CLC data could be memorized and never stored physically on any medium.

For the purpose of this illustration of an account take over, let us assume that one of this User's accounts at one of the Service Providers is breached. A Malicious User now has access to the compromised credential (121).

The Malicious User can then use this credential data against a multitude of other Service Providers in the anticipation that the same User might have setup an account with a different Service Provider using the same credentials. If the credentials match (122) at a different service provider, the fraudster has successfully taken over that account. The Malicious User might decide to change the password so that the legitimate User is now locked out of their own account.

If the Malicious User has taken control of the User's primary email account (122), they can then try to take over the victim's accounts at other Service Providers even if they use a different set of credentials (123). This is done primarily by requesting a password reset. Most Service Providers send out an email with a secure link to the User's email address. Since the Malicious User has access to the email account, they now can use this secure link to gain access to the User's account at the Service Provider. This is also known as Cross Account Takeover.

A detailed profile of the customer's “password hygiene” can be built by analyzing the patterns of their breached identities. If the clear-text passwords for multiple breaches are similar, or minor variants of the same default password, then there is a high risk that a fraudster can try a small number of permutations of the base password at other sites and have a higher probability that it will match.

Those skilled in the art can apply common technique to analyze the password complexity of the exposed passwords—for example, some of the passwords such as “Password1!” meet the rules for having one uppercase character, one number and one special character, but are still extremely easy to guess and would have a very low password complexity score. Other low complexity passwords with a very high risk score contain common English phrases such as “tiger123” or “IloveLucy1”, etc. In contrast an exposed password such as “PrXy.N(n4k7#L!eVAfp9” suggests that the User has a very high standard for password complexity.

Those skilled in the art can apply techniques such as the Levenshtein Distance (https://en.wikipedia.org/wiki/Levenshtein_distance) which measures the minimal number of single character edits to transform one string to another. For example, the Levenshtein Distance for “kitten” to “sitting” is 3.

Another important metric for password complexity is the length of the password. If the user frequently uses short passwords (8 characters or less), their credential risk score is high since there are fewer permutations of a short string.

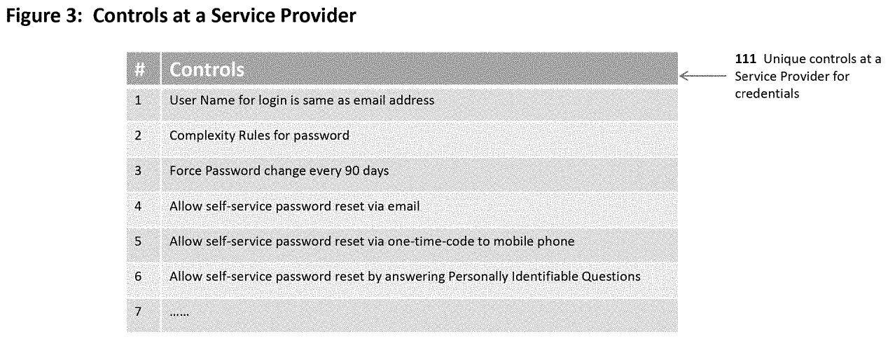

FIG. 3 is an illustration of some of the numerous controls of a given Service Provider for validating and resetting Customer log-in credentials CLC. This information is rarely revealed publicly by a Service Provider. However, Malicious Users constantly experiment and probe to reverse-engineer the controls of a Service Provider. They share their findings on chat rooms on the Dark Web with other Malicious Users. This information is extremely useful in honing a targeted attack against a Service Provider by taking advantage of vulnerabilities in their controls.

By proactively working with the Service Providers, the Credential Risk Scoring Engine (170) documents the same level of information that is available to the Malicious Users. This information is encoded into a data model that is a unique profile for each Service Provider (172).

For example, numerous Service Provider require that the Customer identify the last 4 digits of their Social Security No. (SSN) before they can reset their online password. Other banks require the user to enter their bank account number or card number as an alternative to their username. If an SP relies on the user to type in the last 4 digits of their SSN for resetting the password and this information about the user is available in the Customer Profile (170) of the reduced-False Positives Risk Scoring Engine, then this would indicate a higher risk score.

In one embodiment, the present disclosure relates generally to the field of computing system security, and more specifically to detecting, assessing, and mitigating the risk of third-party fraud in customer interactions with a Service Provider, with assistance of dark web analytics. More specifically, the present invention combines the dark web data of the Applicant with the Applicant data source that is outside of the dark web, to accomplish the risk profile of the specific third-party fraud.

U.S. Pat. No. 11,140,152, which is incorporated by reference herein, describes how risk is assessed using information and data from dark web. The present invention combines such information from the dark web with the Applicant data source to arrive at a reduction in false positives rate in identification of the fraud, particularly third-party fraud.

The current invention monitors the dark web for leaked data related to an Applicant's previous log-in credentials (CLC) at a service provider, such as usernames, email addresses, passwords, PIN codes and other personally identifiable information (PII). It then combines the Applicant-specific dark web data with non-dark web data or Applicant data source to arrive at a progressively accurate machine learning model and exercise that allows for risk detection, assessment, and mitigation.

This invention is described in terms of credit-card applications and the financial institution as the Service Provider. However, the invention equally applies to any Applicant-Service Provider scenario where a third-party fraud is in question.

By “Alert Rate” herein is meant the percent total applications that the present invention's model alerts to Service Provider regarding fraudulent third-party applications. By “Account Detection Rate” (“ADR”) is meant the percent of fraudulent applications detected in the Alerts generated by the model of the present invention. By “Hit Rate” is meant the percent of actual fraud detected in the Alerts that the model flagged.

By “False Positives Rate” is meant the inverse of the Hit Rate. In other words, False Positives Rate+Hit Rate=100%.

In one example, 500 applications in a set of 100,000 applications are fraudulent. The model flags 2% Alerts, that is 2000 total applications for the 100,000 applications. If the model detects 300 of the 500 fraudulent applications, the Account Detection Rate is 60%, that is, ADR=100 [(500−300)/(500)]. The Hit Rate is 300/2000=15%. The False Positives Rate is the inverse of Hit Rate, that is, in the above example, it is 2000−300=100%−15%=85%.

In one embodiment, a preferred Hit Rate is greater than 15%. In another embodiment, the range of Hit Rates is from about 2% to about 99%. State another way, the Hit Rate is any one number, in percentage, selected from the following numbers or is within a range defined by any two numbers including the endpoints of such ranges:

1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

Stated differently, the False Positives (FP) Rate is any one number, in percentage, selected from the following numbers or is within a range defined by any two numbers including the endpoints of such ranges:

0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98 and 99.

In one embodiment, the FP Rate is in the range of 0 to 5% of the fraud identified. In another embodiment, the FP Rate is 0-10%. In yet another embodiment, the FP Rate is 0-20%.

In some instances, even lower Hit Rates are viable, especially if the loss per fraud account is very high. In one embodiment, the financial institution's fraud team will manually work each of the Alerts. At 15%, roughly 1 in 6 alerts are Fraud and that is a reasonable ratio for the Fraud team to work each of those 6 cases to do further due diligence to prevent the fraudulent account. Generally, in a credit card application use case, loss per account is $1,000. In other use cases such as deposit accounts or investment accounts, the loss per account could be much higher, for example, $10,000 per fraudulent account. In those cases the financial institutions may be willing to accept a lower Hit Rate, which can be availed by increasing the Alert Rate of the model.

A preferred use case is a less than 4% Alert Rate for the model. A preferred ADR is 35% or higher, preferably greater than 50%. For example, if there are 500 fraudulent applications, the model detects at least 175, and preferably 250 or higher.

It has surprisingly been found that using just dark web data on prior breaches as a predicate for a third-party fraud would be highly inaccurate, and give a very high False Positives rates. This is counterintuitive, but true. While not wishing to be bound by any theory, it is surmised that most U.S. consumers' identities have been breached in prior breaches given the pervasiveness of data breaches. As a result, looking simply for matches of an Applicant's data such as PII on the dark web from prior breaches, and predicting fraud will result in high number of false alerts and false positives. In fact, we have found that greater than 80% of the credit applications have matches on the dark web from prior breaches. Therefore, using only the dark web data, without more, or nominally more, will not provide the accuracy desired in the industry. The present invention addresses this issue, and solves the problem providing a viable product.

This invention predicts fraud and mitigates it by working backwards from how Fraudsters acquire the personally identifiable information (PII) and the tactics Fraudsters are using and reverse engineer the data that can pinpoint the fraudster tactics. In one embodiment, this invention relates to combining dark web data from prior breaches along with Applicant data source to arrive at the set of datapoints to which the predictive model is applied. Applicant data source includes, for example, behavioral data and data pertaining to the PII attributes such as phone number and email that are given by the Applicant. So a combination of the dark web data or prior breach data with Applicant data source that is then processed via the machine learning models of the present invention provides good predictive ability for third-party fraud. As used herein, the term “exposed data” or “compromised data” or “previously breached data” refers to any part of customer log-in credential (CLC) or personally identifying information (PII) that may have been compromised or breached, such that an unauthorized individual may have gained access to such information. In certain embodiments, the PII data may include names, dates of birth, usernames, passwords, addresses, social security numbers, email addresses, phone numbers, credit card numbers, bank information, employment history, other data, or any combination thereof.

In one embodiment, in the first step, previously breached data from the dark web are collected. In the next step, from the Applicant data source, at least one data point such as an e-mail or phone number are considered and compared. If a good match is found between the Applicant data source data point and the previously breached data, the application to the Service Provider by the Applicant is considered is more likely than not, not to be fraud. A third-party fraudster may not want to provide a good email and/or phone number as those could be used to validate the identity of the customer.

### How Data are Stolen

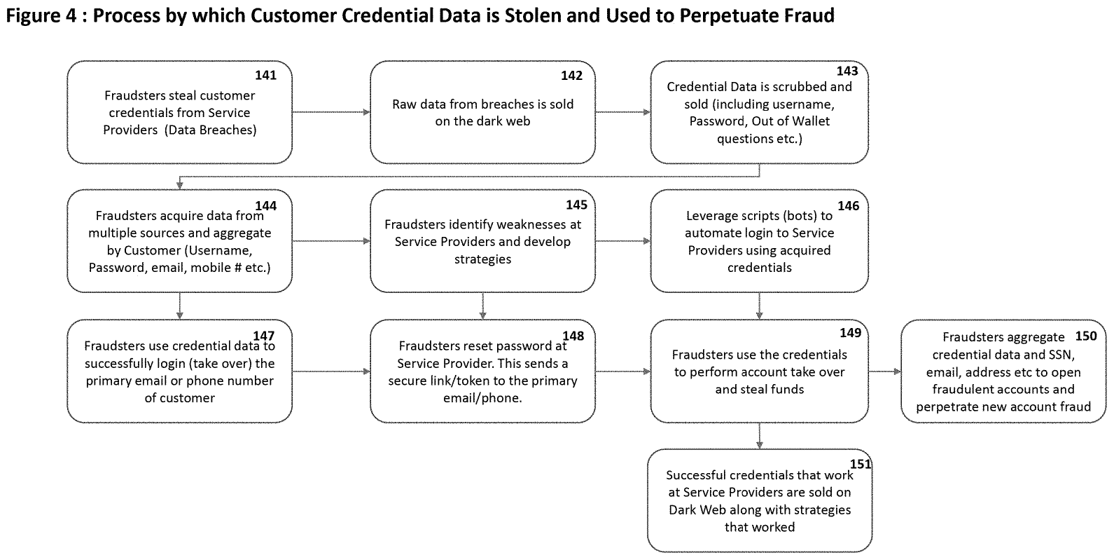

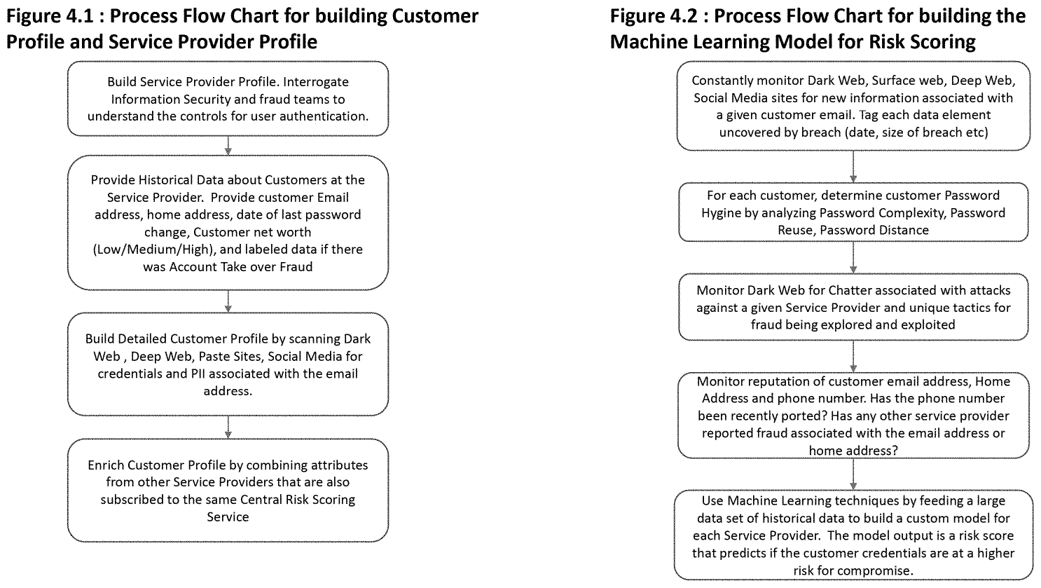

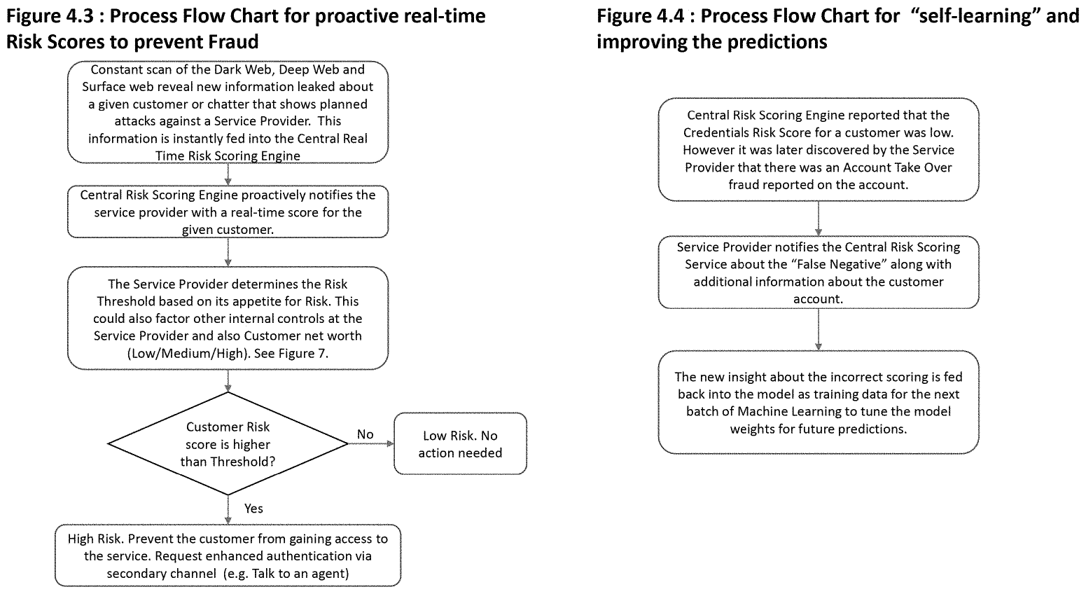

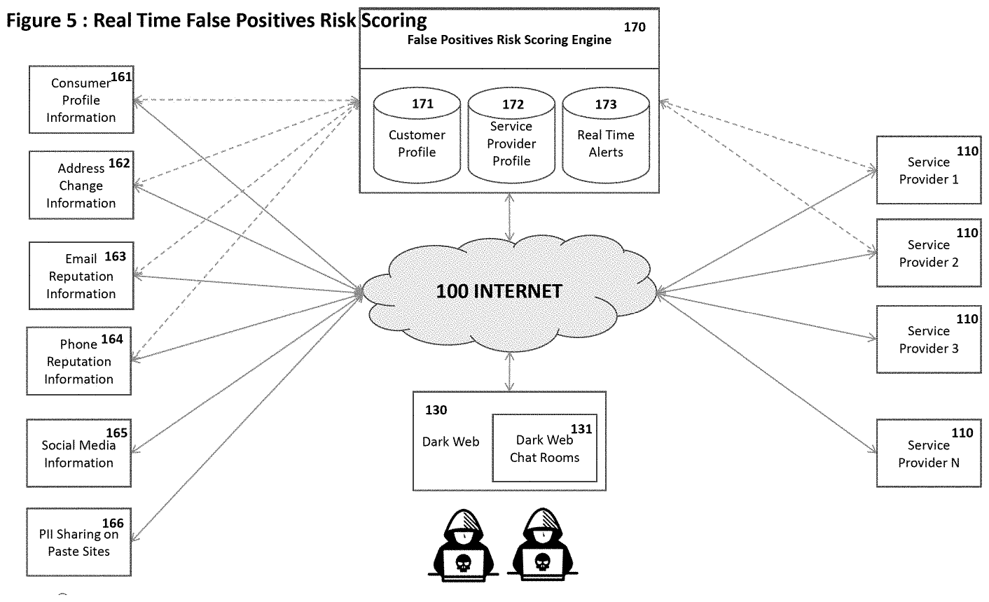

FIG. 4 describes the typical process by which the CLC data are stolen, aggregated, and weaponized against multiple Service Providers. In one embodiment, the process of the present invention mimics these same data gathering enrichment techniques used by the Malicious User to then create a pre-emptive, real-time Credential Risk Score for a given User at a given Service Provider at a given point in time.

### Box 141

This box shows how Malicious Users harvest millions of credentials. Every Service Provider is under attack daily from thousands of Malicious Users who use sophisticated tools to exploit vulnerabilities in their setup. If a Malicious User manages to successfully breach a Service Provider, their bounty typically includes the stored CLC at the Service Provider, which contains the usernames, passwords and other personally identifiable information (PII) about the Customers at that Service Provider. Very often the Service Provider may not be able to detect the breach in a reasonable time, or sometimes not at all. As a result, the User may not be aware that his CLC data are now compromised and in the hands of a Malicious User.

In addition to data breach events, PII can be compromised through “phishing,” which refers to a process of masquerading as a trustworthy entity in an electronic communication. An example of phishing may include a fraudulent email that appears to be from a valid source, such as, for example, a national bank or a credit card company. The fraudulent email may incorporate a uniform resource locator (URL) that re-directs the user to a fraudulent website that masquerades as a legitimate website for the real company. However, the fraudulent website may be designed to steal PII via a false transaction. For example, the fraudulent website may request “confirmation” of PII, such as, for example, a credit card number or a username and password. The “confirmed” PII may then be stored for later improper use.

### Box 142

Once collected, the CLC and the PII data may be sold on a black market through various web sites and illicit data sources. Such web sites and data sources may not be registered with standard search engines, making them difficult to find through traditional web searches. Such web sites and data sources may be part of the dark web, which can be represented by a large number of web servers that do not permit search engine indexing and which host information for Malicious Users.

### Boxes 143 and 144

They represent the aggregation of data by Malicious Users by linking a single User's account information across multiple breach events across multiple service providers. These data are further enhanced through searches across the surface web, social media sites, publicly accessible data such as addresses and work history, from websites to form a detailed profile about the User.

### Box 145

Malicious Users constantly experiment and probe the authentication portals to reverse-engineer the controls of a Service Provider. A Malicious User might setup a new account with a Service Provider to learn about their strategies for validating usernames and passwords. For example, some financial institutions allow a customer to sign in using their 16-digit debit account number instead of their username. Some Service Providers ask for the last 4 digits of a User's SSN to reset a password. Other Service Providers allow multiple failed login attempts without locking out the account. This information is critical to formulating a strategic attack against the Service Provider since it lets the Malicious User know about what additional pieces of information to collect.

### Box 146

Malicious users use automated scripts deployed to hundreds of remote computers or bots to masquerade their login attempts to the Service Providers using the database of the millions of credentials that have been harvested. A very small percent of these automated login attempts do successfully get through, however.

### Box 149, 150, and 151

They illustrate the monetization after a successful account take over.

### Box 147

It shows another valuable strategy of taking over an account using a secondary channel of e-mail or phone. Most Service Providers assume that the email and phone channels are secure. They use these channels as alternate mechanisms to authenticate the user. A Malicious user takes advantage of this assumption. They will first attempt to take over a User's primary email address using the same set of CLC that have been harvested. Once they have full access to a User's e-mail address, they can use the password reset capability of most Service Providers to request a secure link via e-mail. The Malicious User, posing as the Customer now clicks on the link provided by the SP link to reset the password. In some cases, the Malicious User will reach out to the phone service provider of the User and use the data harvested over the dark web to authenticate themselves as the User. They then “port” the User's mobile phone number to their own device. As a result, any text message sent to the User, is now visible to the Malicious User.

### Box 148

The password reset process varies among different Service Providers. Some Service Providers require additional authentication before they send a link to the User's email address. These could include questions such as last four digits of the User's SSN, or the mother's name, or street address. If the Malicious User has done their research in Step 145, they would have already gathered the relevant information about the User using other data sources.

### EMBODIMENTS

In one embodiment, this invention relates to a computer implemented method for reducing the risk of detecting false positives of a third-party fraud in application for an account by an Applicant, for example, when an Applicant is trying to open a new credit-card application.
In the first step, a first datapoint such as an Applicant's email, is considered from the Applicant's application.
In the next step the dark web is continuously searched for first data elements, designated as Xs (“Xs” is simply the plural of the data element “X”) associated with said at least one first datapoint, that is, the email as an example. The dark web scouring is performed to determine if the at least one first datapoint has been breached, the extent of the breach, the timing of the breach, and so on and so forth. The searching is performed in at least one website of the dark web. In one embodiment, the dark web is accessible over an anonymous network.
In the next step, the first data elements of the previous step, that is Xs, are weighted by their importance or lack thereof, wherein the weighted first data elements are called WXs.
In the next step, at least one second data element (Ys) is gathered from information that is not from the dark web is provided. In the first option, the at least one non-dark web second data element is used, as is, that is, as Y, in conjunction with the Xs and the WXs.
Optionally, and similar to the treatment of the first data elements (the Xs), the Ys, or the second data elements—as associated with the at least one second datapoint that is gathered from information not from the dark web to determine breaching of said at least one second datapoint—are also continuously searched in the WEB, or optionally only in the non-dark web space.
In the next step, the second data elements from the above step are weighted, and are called WYs. In the next step, the weighted first data elements (WXs) are combined with at least one second data element (Ys) (WXs+Ys), or
the weighted first data elements (WXs) are combined with the weighted second data elements (WYs) (WXs+WYs).
The purpose of the present invention is to efficiently determine how many of applications (new or otherwise) are fraudulent. The determination is made using the following formula for a reduced-False Positives Risk Score for said application of said Applicant Cn:

r-R_{fp}(Cₙ,SPi,t)=f{X1,X2,X3 . . . ;Y1,Y2,Y3 . . . }

wherein the reduced-False Positives Risk Score r-R_{fp} is specific to a Customer Cn, at a specific Service Provider SPi, and at a given time t;
wherein said reduced-False Positives Risk Score is a function of Xs and Ys, wherein said Xs are data elements from the dark web and Ys are data elements not from the dark web;
wherein said reduced-False Positives Risk Score is calculated using multivariate machine-learning models such that they intelligently analyze said data elements Xs and Ys and provide said reduced-False Positives Risk Score; and
wherein said account is optionally a new account.
Stated differently, the Risk Score can also be calculated based simply on the data elements of the dark web, in which case, the formula would be as follows:

R(Cₙ,SPi,t)=f{X1,X2,X3 . . . }

Stated differently, in one embodiment, the r-Rfp is a significant improvement upon R.
In one embodiment, the Xs and the Ys are weighted after they are combined as data elements. In another embodiment, first the Xs are weighted, and then, the Ys are weighted.

### Dark Web Data Elements (Xs)

In one embodiment of this invention, the Risk Scoring engine or the reduced-False Positives Risk Scoring Engine follows the same processes as described in Box 141, 142, 143, 144, 145, 147 and 148. By leveraging the same data that is used by Malicious User, and adopting similar methods as the Malicious User, the FPRS Engine can evaluate for any point in time, for any given user and a service provider by weighing in, for example, the following questions:
How many of the credentials are available to Malicious Users?
What is the password hygiene of the given user in terms of re-use of the same credentials or simple variants of the same password across other Service Providers?
Can the Malicious User tie back the credentials to a User's email address, mobile phone, and street address?
How long has the User had the same phone and email address?
Have other Service Providers reported recent fraud using the same email address?
Has there been a recent change to the User's street address?
Did someone recently port the mobile phone number for the User's phone?
How much of the CLC and the PII of the given User could be visible to the Malicious Users? (last 4 of the SSN, mothers name, birth date, work and address history, etc.)?
What are the specific weaknesses at a Service Provider that can be compromised by the information gained above?
Is there any active ‘chatter’ on the Dark Web about planned attacks against the Service Provider?

Historically, the predictions of fraud have been based on a rule-based approach where hundreds of static rules are coded in advance to analyze if a given login via a credential is fraudulent or not. In contrast, the present invention leverages techniques of Machine Learning to build its prediction model. The approach of the present invention relies on analyzing huge volumes of historical data to find hidden patterns to build a model that can be used to make predictions on new unseen data. In addition, in one embodiment, the dark web is continuously searched to make the risk score dynamic, for a specific moment in time, for a particular Customer, as it relates to a specific Service Provider. In one embodiment, the dynamic risk score is computed unrelated to a transaction the Customer/Applicant may make at any time. In another embodiment, the risk score is not dynamic, but prepared from periodic searching of the dark web or the WEB. In yet another embodiment, the invention relates to a new Applicant to a Service Provider. In a further embodiment, the invention relates to an Applicant who is known to a Service Provider. In one embodiment, the Service Provider is a credit-card company. In another embodiment, a new Applicant is applying for a new credit card at a credit-card company.

When additional compromised data will appear on the WEB, particularly the dark web, cannot be known. As a result, a dynamic risk score can be preferred by a Service Provider.

In addition, a skilled person must contend with the transient nature of such compromised data as they relate to CLC and PII of a Customer at an SP. Similarly, if the searching is not continuous or dynamic, for example, specific to the transaction, and at the time of the transaction, the risk score assessment may not be accurate, and basically static. This invention, in one embodiment, relates to a continuous searching of information relating to a CLC and/or PII of a Customer at an SP.

In one embodiment of the present invention, a customized machine learning model is created for a given Service Provider by gathering historical data from each SP about the CLC/PII of each customer with the additional identifier from the SP (labeled data) indicating if there was any fraud committed during that session.

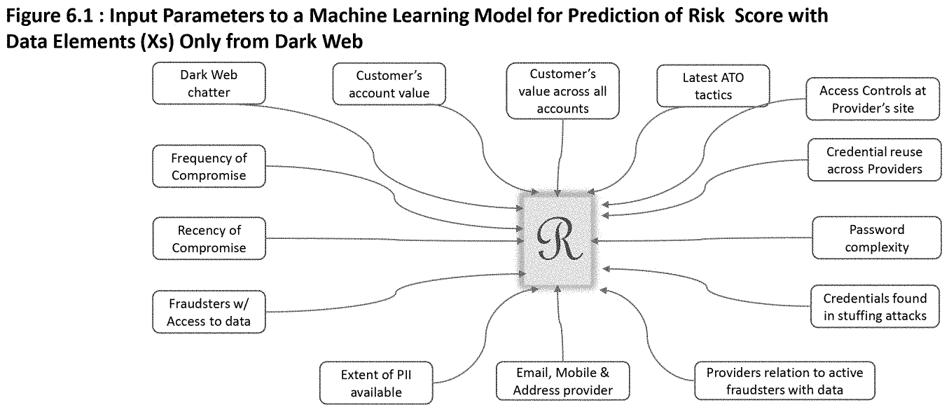

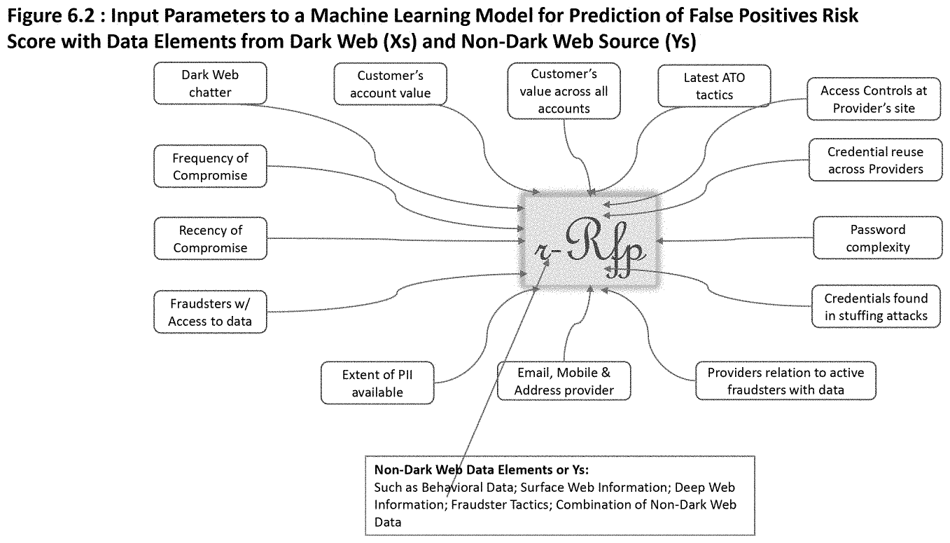

FIG. 6.1 indicates some of the exemplary inputs or data elements (Xs) from the dark web which are packaged from information of compromised data or exposed data or their fragments, that are fed into the machine learning model. These inputs include the following, which is a non-exhaustive list:

1. Dark web chatter
2. Frequency of compromise of the credentials
3. Recency of compromise
4. Fraudsters with access to data
5. Extent of PII available
6. E-mail, mobile and address provider information
7. Service Provider's relation to active fraudsters with data
8. Credentials found in stuffing attacks
9. Password complexity
10. Credential reuse across Service Providers
11. Access controls at Service Provider's site
12. Latest account takeover tactics
13. Customer's value across all accounts (for example net worth in various banks)
14. Customer's specific account value

In one embodiment, the data elements listed above are then weighted through the machine learning models and artificial intelligence models. More data elements are added based on their importance, and/or the data elements that are less important are weighted downward or are weighted zero (essentially, removed from consideration). It is an interactive and intelligent computer model that automatically weighs the data elements once more data are available from various sources.

FIG. 6.2 shows additional input, that of the Ys, from the non-dark web sources.

Those skilled in the art of building machine learning models, can apply numerous techniques such as Logistic Regression, Naïve Baise Classified, Support Vector Machines (SVM), Boosted Decision Trees, Random Forest, Neural Networks, or Deep Learning, to arrive at a model that, for example, in one embodiment, accurately classifies a given transaction as fraud/not-fraud. In addition, the model is further fine-tuned to create a probabilistic risk score by “training” the model on different subsets of this large historical session data. The data are continuously collected for the given Service Provider and across the board from many service providers.

Optionally, the above set of data elements Xs is combined with additional data elements, Ys, which relate to Applicant data source as described below to accurately reduce false positives.

### Applicant Data Source—Non-Dark Web Data Elements (Ys)

In one embodiment, apart from the steps outlined above the models of the present invention use other data elements (Ys) from the Application data source, and optionally from the deep web, and surface web to further refine and reduce the false positives.

In one embodiment, other data elements (Ys) used in the model include behavioral data. For example behavioral difference in subjective or objective behavior of a Fraudster as an Applicant in a third-party fraud scenario and a genuine Applicant or a real customer or a real client for an application to a Service Provider. Other data points that are considered include the time of the day of the application, the velocity of the behavior, that is the propensity of the Fraudster to use the same e-mail and or phone number for multiple accounts but with different identities.

In another embodiment, the other data elements (Ys)—apart from the previously breached data from the dark web (Xs)—include information from the surface web. Such information includes, for example, data on phones. These data include differentiated information on telephone carriers, for example, whether the telephone carrier is a major or a mainstream telephone carrier such as AT&T, Verizon, and T-Mobile versus short-term or a pre-paid phone plan, for example, Boost Mobile and Cricket Wireless. In this embodiment, the model also considers additional information such as recycled phone numbers, temporary phone numbers such as from Google, phone numbers with no prior data, and geolocation of the phone number versus the address on the application provided by the Applicant.

In one embodiment, the other data elements (Ys)—apart from the previously breached data from the dark web (Xs)—include data in e-mails. For example, e-mails include differentiated information such as domain names (or their fragments), that is certain domain names that are easy to open are more commonly used by Fraudsters. Also critically considered in the model of this embodiment are data such as historical activity, that is, if the same email has been used in the past for fraud, the recency of the e-mail account, and the responsiveness of the account.

In one embodiment, the other data elements (Ys)—apart from the previously breached data from the dark web (Xs)—include marketing data, for example from Merkle, a leading marketing company that provides household data that is similar to what is provided on a credit application. Such data elements include household information and address, other e-mails used by the household, which may be used on the Application but may not have the same historical footprint, and association of the PII data provided by the Applicant versus what is found in the marketing databases.

In one embodiment, this invention also uses additional Fraudster tactics that are reverse engineered and incorporated into the machine learning model. For example, fake emails or burner email for a person, fake phone numbers or burner phone numbers for a person that feature a person's name or just spam e-mails for the person. In one embodiment, the additional information includes malware attack information, information on compromised phones, and cases where the 2-step authentication has failed.
The r-FPRS Engine

The r-FPRS Engines differs from the RS Engine in that in the r-FPRS Engine, the data elements input include dark web data and the non-dark web data. The RS Engine includes dark web data elements as input.

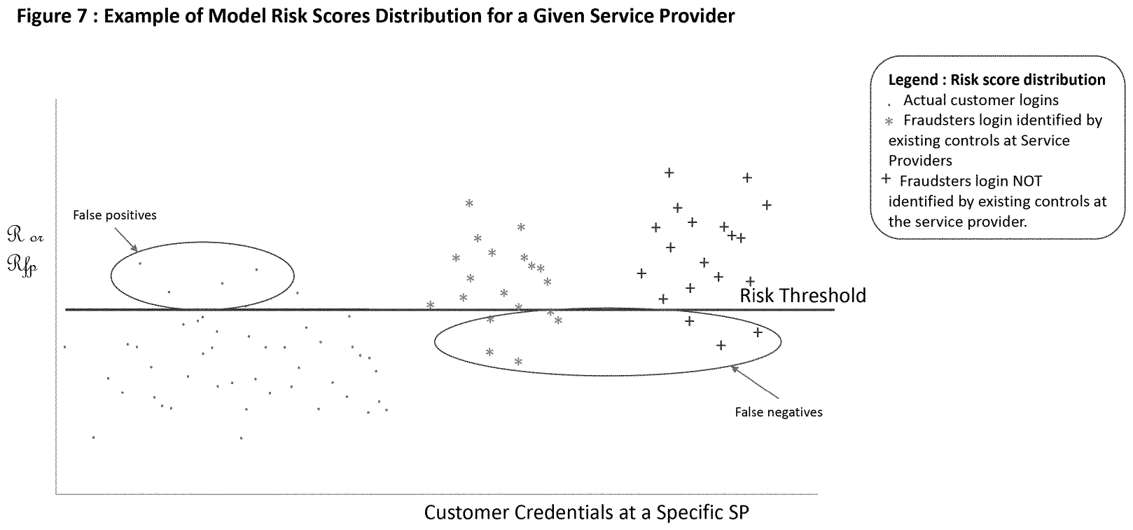

When a machine learning model is used to create a prediction of new data, it is possible that the model might make two different kinds of errors. The model might predict a fraudulent transaction as non-fraud (this is a false negative) or it might incorrectly flag a valid CLC as a fraudulent one. A model that predicts a high number of false positives will cause a high number of customer satisfaction issues since their valid logins are being flagged as fraudulent. The SP then alters and further fine-tunes the model by defining the precision and recall parameters, as shown in FIG. 7 to find the right balance of false positives to false negatives based upon their unique needs.

While the present invention is discussed in the terms of application fraud, for example, application for credit card with a financial institution, the method of this invention can also be used to predict fraud in other use cases. For example, the present invention applies to account takeover fraud, wherein the Fraudster uses known customer PII and/or phone and email access, to change credentials and access the account fraudulently. This type of fraud happens after the Service Provider-Customer relationship is established. Other use cases for the present invention include for tracking and mitigating first-month loan defaults, payment fraud, and rewards account fraud.

In one embodiment, the present invention applies to insurance fraud, wherein a third-party fraud occurs when the Fraudster tries to open an account in some other person's name with the purpose of filing fraudulent claims.

In one embodiment, the data elements (Xs and Ys) discussed previously are then weighted through machine learning model and artificial intelligence models. More data elements are added based on their importance, and/or the data elements that are less important are weighted downward or are weighted zero (essentially, removed from consideration). It is an interactive and intelligent computer model that automatically weighs the data elements once more data are available from various sources.

Those skilled in the art of building machine learning models, can apply numerous techniques such as Logistic Regression, Naïve Baise Classified, Support Vector Machines (SVM), Boosted Decision Trees, Random Forest, Neural Networks, or Deep Learning, to arrive at a model that, for example, in one embodiment, accurately classifies a given transaction as fraud/not-fraud. In addition, the model is further fine-tuned to create a probabilistic risk score by “training” the model on different subsets of this large historical session data. The data are continuously collected for the given Service Provider and across the board from many service providers.

The multivariate and logistic regression models that have machine-learning capabilities are designed such that they intelligently analyze all data elements (Xs and Ys) and predict the risk of credential compromise of given customer, Cn, at a specific Service Provider, SPi at a specific point in time “t”. The three dimensions of the Risk Score are denoted as: r-R_{fp} (Cₙ, SPi, t) and is a complex function of the Xs and Ys noted above as the data elements required for modeling the risk. As it relates to the risk factor R:

r-R_{fp}(Cₙ,SPi,t)=f{X1,X2,X3 . . . ;Y1,Y2,Y3 . . . }

In other words, r-R_{fp} is a complex multivariate function of the several data elements, or Xs and Ys. Stated differently, the basic unit of a credential that is availed for risk detection and mitigation incorporates the specific SP characteristic at a specific time. The risk factor R_{fp} is dynamic and changes with time for a given credential at the given SP. This invention also envisions preparing a risk profile for a credential that is function of time. In other words, for a give credential associated with an SP, the SP can get a real-time “health report” of the credential.

Clearly, the risk factor without the correction for reducing the false positives would be given by:

R(Cₙ,SPi,t)=f{X1,X2,X3 . . . }

The SP has the flexibility to automatically flag accounts that cross a particular risk-factor-R (or r-R_{fp}) threshold, generate an account alert, and/or seek pre-emptive and one or more than one self-authentications from the Customer, up to the extent determined by the model, that will reduce the risk factor R or r-R_{fp} below the set threshold. In one embodiment, the self-authentication is pre-emptive, which means even before a transaction originates, the authentication is put in place, thereby avoiding a reactive or a corrective approach. In one embodiment, the self-authentication is not specific to a transaction.

The complexity of the model entails sophisticated big-data analytic techniques to predict the risk for compromise. In one embodiment, the risk rating is validated with real data from the SP to tune the model initially, but to enhance the ML capabilities, the actual compromised credentials at the SP are fed back into the model at a regular frequency to ensure the underlying elements are appropriately utilized by the model, and new elements that may not be envisioned previously be added such that the model updates as the macro conditions change: fraudsters change tactics; the SP's controls improve; and customers increase use of advanced controls such as multi factor authentication. The model not only uses updated data as the macro conditions change, but also self-tunes to continually improve its predictive ability.

When a machine learning model is used to create a prediction of new data, it is possible that the model might make two different kinds of errors. The model might predict a fraudulent transaction as non-fraud (this is a false negative) or it might incorrectly flag a valid CLC as a fraudulent one. A model that predicts a high number of false positives will cause a high number of customer satisfaction issues since their valid logins are being flagged as fraudulent. The SP then alters and further fine-tunes the model by defining the precision and recall parameters, as shown in FIG. 7 to find the right balance of false positives to false negatives based upon their unique needs.

Once the machine learning model has been customized for the needs of a given SP, the real-time reduced-False Positives Risk Scoring Engine (170) continuously scans the WEB (dark web+deep web+surface web) for new privacy leaks and data breaches that expose the User CLC and PII.

In one example, let us assume that there is a customer with accounts at multiple SPs, each of whom subscribe to the same real-time reduced-FPRS Engine. The real-time risk score for the same individual customer has a static component based on the user's profile (number of breaches of the same user credentials, and password hygiene) and also has several dynamic components (recency of breaches, date of last password reset at that service provider, recency of email account take-over or mobile phone account takeover, chatter on the dark web about imminent planned attacks against a service provider). In one embodiment, the reduced-False Positives Risk Score for the same User or Applicant could differ significantly based on the unique controls at each Service Provider. For example, a service provider that leverages use of password resets via last 4 digits of the SSN will have a higher real time reduced-False Positives Risk Score if this customer's SSN is leaked on the dark web.

All of these features, feed into a machine learning model that provides a real-time reduced-False Positives Risk Score. The machine learning model is further enhanced by a feedback loop from the Service Provider that reports on the accuracy of the predictions.

In one embodiment, this invention relates to computer program product comprising a computer readable storage medium comprising a computer readable program code embodied therewith, the computer readable program code comprising computer readable program codes configured to perform the method steps described previously.
In another embodiment, this invention relates to a system comprising a set of data processors configured to execute a sets of instructions to perform the methods steps outlined supra.

### Process Steps of the Invention

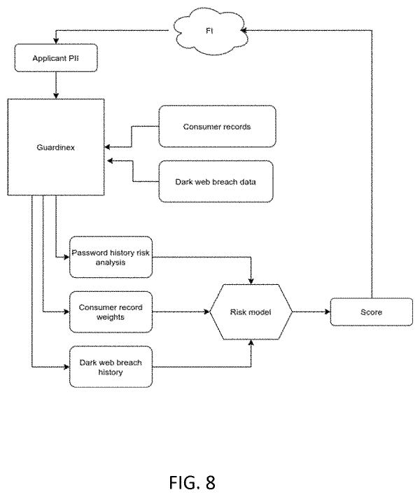

As shown in FIG. 8, in the first step, an Application, for example, for credit solicitation arrives from a financial institution with the PII information of an Applicant. The invention system, that is its search engine, retrieves data available on the dark web on the Applicant's record, that is the email and phone number history and activity.

In the next step, the breach data is analyzed, for example the password history is scored using several matrices. In addition, other breach records are enumerated, for example, if the social security number was leaked, if the credit card number was breached, and the recency of breach data and the historical breach trends are analyzed.

In the next step, the dark web breach history for the particular Applicant is screened using the assembled consumer records. This can entail adding weights to the breach data depending on reliability of the consumer record and adding weights to the breach data representing accuracy of the application in comparison to the consumer record.

Weights are also added to the breach data representing relevancy of breach data to the Applicant. For example, in one embodiment, Applicant data breached could be weighted 1.0; spouse or close relation data breached could be weighted 0.5; data breached about email accounts for Applicant that were not included on the application for credit could be weighted 0.25; and “stale” data about Applicant that are outdated when compared to consumer records might be disregarded. In one embodiment, these weights may also be determined using machine learning model s.

In the next step, all resulting data and weights are input into the predictive model of the present invention. The predictive model provides a score that is then returned to the financial institution as to the risk of the Applicant.

In one embodiment, the presence of the breached data on the dark web is weighted in the direction of genuineness of the account.

### EXPERIMENTAL

### Example 1

These statistics were evaluated on real-world data with a fraud rate of 0.8%. In this example, the predictive engine of the invention used only the dark web data as baseline and compared it to the prediction from the dark web combined with consumer data records. In order to detect the same percent of overall fraud (recall ADR=account detection rate), the two models must alert on different percentages of the population. By adding consumer data, the rate of False Positives improved significantly (that is, it was reduced).

(False Positives Rate=false positives/all negatives. In other words, the percent of the innocent population the system alerts on.)

TABLE 1
Dark Web Data Versus Dark Web + Consumer Data
and Impact on False Positive Rate

| | | | With additional screening | |
|---|---|---|---|---|
| | Only Dark Web Data | | using consumer data | |
| | | False | | False |
| | Required | Positives | Required | Positives |
| ADR | alert rate | rate | alert rate | rate |
| 30% | 2.7% | 2.5% | 0.6% | 0.4% |
| 55% | 7.8% | 7.4% | 1.8% | 1.3% |
| 85% | 20.7% | 20.1% | 9.6% | 8.9% |

### Example 2

In this example, real-world actual data were fed into the r-FPRS engine of the present invention and was compared to two external models for comparison purposes. The results were based on a sample of 60,221 digital new accounts. For each competitor, a model was built their pre-existing fraud-detecting features. For the invention model, a combination of dark web, surface web, and identity verification features were utilized. All three results used cross-validated random forest models with fixed parameters.

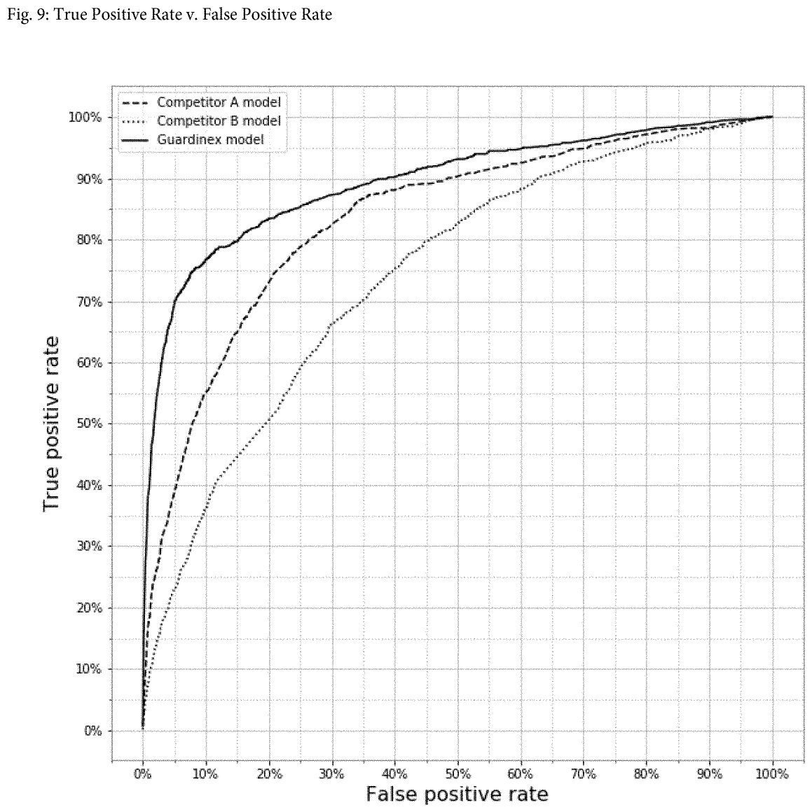

True positive rates of fraud detection were plotted as a function of false positive rates of fraud detection for the invention model and the two comparison models as shown in FIG. 9. Table 2 below compares results at the same false positive rate for each model. Higher true positive rate is considered a better result as more detection for less of a cost from the false positives.

As shown in Table 2, at a low false positive rate of 1%, the invention model is 118% better than model A and 330% better than model B in terms of detecting true positive rate of fraud. Even at a very high false positive rate, that of 20%, the invention model is 13% and 59% better than Models A and B, respectively. Stated differently, at all false positive rates of fraud detection, the invention model showed large and surprising improvement over the conventional models. Even with a 10% false positive rate, the invention model achieved a more than 75% true positive rate. Comparative Model A achieves a close to 75% true positive rate only when its false positive rate is at 20%, that is, double of that of the present invention. As to the Comparative Model B, at a 20% false positive rate, its true positives are about 50%. In other words, for every five applications that Model B flags as truly fraudulent, it falsely flags two genuine accounts also as fraudulent. Comparative Model B's efficiency is not helpful at all in identifying fraud efficiently. Through its novel approach, the present invention shows how to efficiently identify fraud, without frustrating too many genuine Applicants and account holders.

TABLE 2
True Positive Rate as a Function of False Positive Rate

| False | | | | % Improvement | % Improvement |
|---|---|---|---|---|---|
| Positive | Model A--True | Model B--True | Invention--True | of Invention | of Invention |
| Rate | Positive Rate | Positive Rate | Positive Rate | Over Model A | Over Model B |
| 1.0% | 17.9% | 9.1% | 39.2% | 118% | 330% |
| 2.5% | 27.6% | 15.5% | 56.4% | 104% | 264% |
| 5.0% | 38.7% | 23.0% | 69.5% | 80% | 248% |
| 10.0% | 55.1% | 36.1% | 76.7% | 39% | 112% |
| 15.0% | 65.1% | 52.5% | 79.6% | 22% | 52% |
| 20.0% | 74.0% | 52.5% | 83.4% | 13% | 59% |

What is claimed:

1. A computer implemented method for reducing the risk of detecting false positives of a third-party fraud in application for an account by an Applicant, comprising the steps of:
(A) taking at least one first datapoint from the Applicant's application;
(B) continuously searching first data elements (Xs) associated with said at least one first datapoint to determine breaching of said at least one first datapoint, wherein said searching is performed in at least one website of the dark web and wherein said dark web is accessible over an anonymous network;
(C) weighting the data elements of Step (B), wherein the weighted first data elements are called WXs;
(D)
(D1) providing at least one second data element (Ys) gathered from information that is not from the dark web; or
(D2) continuously searching second data elements (Ys) associated with at least one second datapoint that is gathered from information not from the dark web to determine breaching of said at least one second datapoint;
(E) weighting the second data elements of Step (D2), wherein the weighted second data elements are called WYs;
(F) combining the weighted first data elements (WXs) from Step (C) with at least one second data element (Ys) from Step (D1) (WXs+Ys), or combining the weighted first data elements (WXs) from Step (C) with the weighted second data elements (WYs) of Step (E) (WXs+WYs);
(G) determining a reduced-False Positives Risk Score for said application of said Applicant Cₙ using the formula:
r-R_{fp}(Cₙ,SPi,t)=f{X1,X2,X3 . . . ;Y1,Y2,Y3 . . . }
wherein the reduced-False Positives Risk Score r-R_{fp} is specific to a Customer Cn, at a specific Service Provider SPi, and at a given time t;
wherein said reduced-False Positives Risk Score is a function of Xs and Ys, wherein said Xs are data elements from the dark web and Ys are data elements not from the dark web;
wherein said reduced-False Positives Risk Score is calculated using multivariate machine-learning models such that they intelligently analyze said data elements Xs and Ys and provide said reduced-False Positives Risk Score;
wherein said account is optionally a new account; and
wherein said reduction in risk of detecting false positives of the third-party fraud is optionally preemptively performed on an account or an Applicant.

2. The method as recited in claim 1, wherein the information not from the dark web, that is the second data elements (Ys), is selected from the group consisting of:
(i) behavioral data,
(ii) deep web information; wherein, optionally, said searching of data elements in the deep web is based, at least in part, on the information from the dark web,
(iii) surface web information; wherein, optionally, searching the data elements in the surface web are based, at least in part, on the data elements' information from the dark web and/or the deep web,
(iv) additional fraudster tactics, and
(v) a combination of the above.

3. The method as recited in claim 2, wherein the second data elements (Ys) are selected from:
behavioral difference in subjective behavior of a Fraudster as an Applicant in a third-party fraud and a genuine Applicant; behavioral difference in objective behavior of a Fraudster as an Applicant in a third-party fraud and a genuine Applicant; the time of the day of the application; the day of the week of the application; the month of the application; the propensity of the Fraudster to use the same email for multiple accounts but with different identities; the propensity of the Fraudster to use the same phone number for multiple accounts but with different identities; surface web information relating to differentiated information on telephone carriers; surface web information relating to recycled phone numbers; surface web information relating to temporary phone numbers; surface web information relating to phone numbers with no prior data; surface web information relating to geolocation of the phone number versus the address on the application provided by the Applicant; differentiated information in an email relating to domain names; differentiated information in the email relating to historical activity; differentiated information in the email relating it use in the past for fraud; differentiated information in emails relating to the recency of the email account; differentiated information in emails relating to the responsiveness of the account; marketing data that includes household information; marketing data that includes address of the Applicant; marketing data that includes other e-mails used by the household of the Applicant; marketing data that includes other e-mails used by the household which does not have the same historical footprint as the email of the Applicant; association of the PII data provided by the Applicant versus what is found in the marketing data; Fraudster tactic of fake email for the Applicant that is reverse engineered and incorporated into the machine learning model; Fraudster tactic of burner email for the Applicant that is reverse engineered and incorporated into the machine learning model; Fraudster tactic of fake phone number for the Applicant that is reverse engineered and incorporated into the machine learning model; Fraudster tactic of burner phone number for the Applicant that is reverse engineered and incorporated into the machine learning model; Fraudster tactic of spam emails for the Applicant that is reverse engineered and incorporated into the machine learning model; Fraudster tactic relating to malware attack information for the Applicant that is reverse engineered and incorporated into the machine learning model; Fraudster tactic of information on compromised phones for the Applicant that is reverse engineered and incorporated into the machine learning model; Fraudster tactic of cases where the 2-step authentication has failed for the Applicant that is reverse engineered and incorporated into the machine learning model; and combination of the above.

4. The method as recited in claim 1, wherein said reduced-False Positives Risk Score, as it relates to said specific Service Provider SPi, is dynamically communicated to said specific Service Provider SPi prior to a transaction request, and not after said transaction request using an application programming interface (API).

5. The method as recited in claim 4, wherein said reduced-False Positives Risk Score is compared dynamically or periodically with a pre-determined threshold Risk Score; and taking one of the following steps:
(F1) modifying an authentication requirement for the Applicant and seeking said authentication from the Applicant, wherein said authentication requirement is a function of the breach of said pre-determined threshold Risk Score;
(F2) modifying an authentication requirement for the Applicant, while temporarily suspending services to said Applicant, pre-emptively notifying the Applicant of said suspension, seeking said authentication from said Applicant, and restarting or shutting down services connected to said Applicant.

6. The method as recited in claim 5, wherein modifying the authentication requirement comprises identifying an enhanced security protocol to authenticate the User.

7. The method as recited in claim 6, wherein the enhanced security protocol comprises a multi-factor authentication of the User.

8. The method as recited in claim 1, wherein the data elements comprise one of dynamic content, multimedia content, audio content, and a picture.

9. The method of claim 1, wherein the data elements are searched using configurable search parameters.

10. The method of claim 1, wherein the anonymous network comprises a Tor server.

11. The method as recited in claim 1, wherein said behavioral data is selected from behavioral difference between a Fraudster and a genuine Applicant, the time of the day of the application, the propensity of the Fraudster to use the same e-mail and or phone number for multiple accounts but with different identities.

12. The method as recited in claim 1, wherein said surface web information is selected from data on phone carriers, recycled phone numbers, temporary phone numbers, phone numbers with no prior data, and geolocation of the phone number versus the address on the application provided by the Applicant, domain name information in e-mail, historical activity of the e-mail, the recency of the e-mail account, and the responsiveness of the account.

13. The method as recited in claim 1, wherein said surface web information is selected from marketing data, household information, household address, other e-mails used by the household, and association of the PII data provided by the Applicant versus what is found in the marketing databases.

14. The method recited in claim 1, wherein the dark web data associated with the Applicant datapoint is weighted favorably to reduce the false positives.

15. A computer program product comprising:
a computer readable storage medium comprising computer readable program code embodied therewith, the computer readable program code comprising:
(A) computer readable program code configured to take in at least one first datapoint from the Applicant's application;
(B) computer readable program code configured to continuously searching first data elements (Xs) associated with said at least one first datapoint to determine breaching of said at least one first datapoint, wherein said searching is performed in at least one website of the dark web and wherein said dark web is accessible over an anonymous network;
(C) computer readable program code configured to weighting the data elements of Step (B), wherein the weighted first data elements are called WXs;
(D)
(D1) computer readable program code configured to providing at least one second data element (Ys) gathered from information that is not from the dark web; or
(D2) computer readable program code configured to continuously searching second data elements (Ys) associated with at least one second datapoint that is gathered from information not from the dark web to determine breaching of said at least one second datapoint;
(E) computer readable program code configured to weighting the second data elements of Step (D2), wherein the weighted second data elements are called WYs;
(F) a computer readable program code configured to combining the weighted first data elements (WXs) from Step (C) with at least one second data element (Ys) from Step (D1) (WXs+Ys), or combining the weighted first data elements (WXs) from Step (C) with the weighted second data elements (WYs) of Step (E) (WXs+WYs);
(G) computer readable program code configured to determining a reduced-False Positives Risk Score for said application of said Applicant Cₙ using the formula:
r-R_{fp}(Cₙ,SPi,t)=f{X1,X2,X3 . . . ;Y1,Y2,Y3 . . . }
wherein the reduced-False Positives Risk Score r-R_{fp} is specific to a Customer Cn, at a specific Service Provider SPi, and at a given time t;
wherein said reduced-False Positives Risk Score is a function of Xs and Ys, wherein said Xs are data elements from the dark web and Ys are data elements not from the dark web; and
wherein said reduced-False Positives Risk Score is calculated using multivariate machine-learning models such that they intelligently analyze said data elements Xs and Ys and provide said reduced-False Positives Risk Score.

16. The computer program product as recited in claim 15, wherein the information not from the dark web, that is the second data elements (Ys), is selected from the group consisting of:
(i) behavioral data,
(ii) deep web information; wherein, optionally, said searching of data elements in the deep web is based, at least in part, on the information from the dark web,
(iii) surface web information; wherein, optionally, searching the data elements in the surface web are based, at least in part, on the data elements' information from the dark web and/or the deep web,
(iv) additional fraudster tactics, and
(v) a combination of the above.

17. The computer program product as recited in claim 16, wherein the second data elements (Ys) are selected from:
behavioral difference in subjective behavior of a Fraudster as an Applicant in a third-party fraud and a genuine Applicant; behavioral difference in objective behavior of a Fraudster as an Applicant in a third-party fraud and a genuine Applicant; the time of the day of the application; the day of the week of the application; the month of the application; the propensity of the Fraudster to use the same email for multiple accounts but with different identities; the propensity of the Fraudster to use the same phone number for multiple accounts but with different identities; surface web information relating to differentiated information on telephone carriers; surface web information relating to recycled phone numbers; surface web information relating to temporary phone numbers; surface web information relating to phone numbers with no prior data; surface web information relating to geolocation of the phone number versus the address on the application provided by the Applicant; differentiated information in an email relating to domain names; differentiated information in the email relating to historical activity; differentiated information in the email relating it use in the past for fraud; differentiated information in emails relating to the recency of the email account; differentiated information in emails relating to the responsiveness of the account; marketing data that includes household information; marketing data that includes address of the Applicant; marketing data that includes other e-mails used by the household of the Applicant; marketing data that includes other e-mails used by the household which does not have the same historical footprint as the email of the Applicant; association of the PII data provided by the Applicant versus what is found in the marketing data; Fraudster tactic of fake email for the Applicant that is reverse engineered and incorporated into the machine learning model; Fraudster tactic of burner email for the Applicant that is reverse engineered and incorporated into the machine learning model; Fraudster tactic of fake phone number for the Applicant that is reverse engineered and incorporated into the machine learning model; Fraudster tactic of burner phone number for the Applicant that is reverse engineered and incorporated into the machine learning model; Fraudster tactic of spam emails for the Applicant that is reverse engineered and incorporated into the machine learning model; Fraudster tactic relating to malware attack information for the Applicant that is reverse engineered and incorporated into the machine learning model; Fraudster tactic of information on compromised phones for the Applicant that is reverse engineered and incorporated into the machine learning model; Fraudster tactic of cases where the 2-step authentication has failed for the Applicant that is reverse engineered and incorporated into the machine learning model; and combination of the above.

18. A system comprising:
(A) a data processor configured to execute a first set of instructions to take in at least one first datapoint from an Applicant's application;
(B) a data processor configured to execute a first set of instructions to continuously searching first data elements (Xs) associated with said at least one first datapoint to determine breaching of said at least one first datapoint, wherein said searching is performed in at least one website of the dark web and wherein said dark web is accessible over an anonymous network;
(C) a data processor configured to execute a first set of instructions to weighting the data elements of Step (B), wherein the weighted first data elements are called WXs;
(D)
(D1) a data processor configured to execute a first set of instructions to providing at least one second data element (Ys) gathered from information that is not from the dark web; or
(D2) a data processor configured to execute a first set of instructions to continuously searching second data elements (Ys) associated with at least one second datapoint that is gathered from information not from the dark web to determine breaching of said at least one second datapoint;
(E) a data processor configured to execute a first set of instructions to weighting the second data elements of Step (D2), wherein the weighted second data elements are called WYs;
(F) a data processor configured to execute a first set of instructions to combining the weighted first data elements (WXs) from Step (C) with at least one second data element (Ys) from Step (D1) (WXs+Ys), or combining the weighted first data elements (WXs) from Step (C) with the weighted second data elements (WYs) of Step (E) (WXs+WYs);
(G) a data processor configured to execute a first set of instructions to determining a reduced-False Positives Risk Score for said application of said Applicant Cₙ using the formula:
r-R_{fp}(Cₙ,SPi,t)=f{X1,X2,X3 . . . ;Y1,Y2,Y3 . . . }
wherein the reduced-False Positives Risk Score r-R_{fp} is specific to a Customer Cn, at a specific Service Provider SPi, and at a given time t;
wherein said reduced-False Positives Risk Score is a function of Xs and Ys, wherein said Xs are data elements from the dark web and Ys are data elements not from the dark web;
wherein said reduced-False Positives Risk Score is calculated using multivariate machine-learning models such that they intelligently analyze said data elements Xs and Ys and provide said reduced-False Positives Risk Score;
wherein said Applicant is optionally opening a new account; and
wherein said reduction in risk of detecting false positives of the third-party fraud is optionally preemptively performed on the new account or the Applicant.

19. The system as recited in claim 18, wherein the information not from the dark web, that is the second data elements (Ys), is selected from the group consisting of:
(i) behavioral data,
(ii) deep web information; wherein, optionally, said searching of data elements in the deep web is based, at least in part, on the information from the dark web,
(iii) surface web information; wherein, optionally, searching the data elements in the surface web are based, at least in part, on the data elements' information from the dark web and/or the deep web,
(iv) additional fraudster tactics, and
(v) a combination of the above.

20. The system as recited in claim 19, wherein the second data elements (Ys) are selected from:
behavioral difference in subjective behavior of a Fraudster as an Applicant in a third-party fraud and a genuine Applicant; behavioral difference in objective behavior of a Fraudster as an Applicant in a third-party fraud and a genuine Applicant; the time of the day of the application; the day of the week of the application; the month of the application; the propensity of the Fraudster to use the same email for multiple accounts but with different identities; the propensity of the Fraudster to use the same phone number for multiple accounts but with different identities; surface web information relating to differentiated information on telephone carriers; surface web information relating to recycled phone numbers; surface web information relating to temporary phone numbers; surface web information relating to phone numbers with no prior data; surface web information relating to geolocation of the phone number versus the address on the application provided by the Applicant; differentiated information in an email relating to domain names; differentiated information in the email relating to historical activity; differentiated information in the email relating it use in the past for fraud; differentiated information in emails relating to the recency of the email account; differentiated information in emails relating to the responsiveness of the account; marketing data that includes household information; marketing data that includes address of the Applicant; marketing data that includes other e-mails used by the household of the Applicant; marketing data that includes other e-mails used by the household which does not have the same historical footprint as the email of the Applicant; association of the PII data provided by the Applicant versus what is found in the marketing data; Fraudster tactic of fake email for the Applicant that is reverse engineered and incorporated into the machine learning model; Fraudster tactic of burner email for the Applicant that is reverse engineered and incorporated into the machine learning model; Fraudster tactic of fake phone number for the Applicant that is reverse engineered and incorporated into the machine learning model; Fraudster tactic of burner phone number for the Applicant that is reverse engineered and incorporated into the machine learning model; Fraudster tactic of spam emails for the Applicant that is reverse engineered and incorporated into the machine learning model; Fraudster tactic relating to malware attack information for the Applicant that is reverse engineered and incorporated into the machine learning model; Fraudster tactic of information on compromised phones for the Applicant that is reverse engineered and incorporated into the machine learning model; Fraudster tactic of cases where the 2-step authentication has failed for the Applicant that is reverse engineered and incorporated into the machine learning model; and combination of the above.

21. The method as recited in claim 1, further comprising:
generating a machine learning model with feedback from the Service Provider on the accuracy of the previous score.

22. The method as recited in claim 1, wherein the false positives is in the range of 0-20% of the accounts.
